(19) United States
(12) Patent Application Publication
(10) Pub. No.: US 2004/0015846 A1
(43) Pub. Date: Jan. 22, 2004

(54) System, device and method for integrating functioning of autonomous processing modules, and testing apparatus using same

(75) Inventor: Oved Haisraeli, Nes Ziona (IL)

Correspondence Address: G.E. EHRLICH (1995) LTD., C/O ANTHONY CASTORINA, SUITE 207, 2001 JEFFERSON DAVIS HIGHWAY, ARLINGTON, VA, 22202, US

(73) Assignee: Jupiter Controller, Inc.

(21) Appl. No.: 09/927,541

(22) Filed: Aug. 13, 2001

Related U.S. Application Data
(60) Provisional application No. 60/280,984, filed on Apr. 4, 2001.

(51) Int. Cl. G06F 9/44

(52) U.S. Cl. 717/115; 717/167

(57) ABSTRACT

Supervisor apparatus for running an integrated operation on a plurality of applications distributed on networked stations, the apparatus comprising: an evaluating unit for receiving and evaluating output from at least two stations including a first station and at least one other station, and an operating unit for sending selected commands to a first application running on said first station, said commands being selectable according to rules, said rules specifying a dependency of a command to be sent to said first station upon an evaluation of output from said at least one other station. The apparatus is useful for carrying out integrated functionality or regressive testing of multi-station single or multiple processes.

### RELATIONSHIP TO EXISTING APPLICATIONS

The present application claims priority from U.S. Provisional Application No. 60/280,984 filed Apr. 4, 2001.

### FIELD AND BACKGROUND OF THE INVENTION

The present invention comprises an apparatus and method for running an integrated operation on a plurality of applications distributed on networked stations, and further relates to use of such apparatus and method for integrated testing of such a plurality of applications, that is to say to provide integrated testing of multi-station processing, said multi-station processing being single or multi-process.

Since early modern computer systems, command languages of various sorts have been used as a source of command input for otherwise autonomous processes running on the systems. The JCL language, in early IBM mainframe systems, was an early example of a script used for sequencing autonomous or semi-autonomous processes. The “pipe” system, part of Unix since its inception, has been a convenient shorthand for indicating that the output of one process is to be presented as input to another process.

The sophistication of such interactions, however, has remained somewhat limited, while computer systems have evolved greatly since those early days. Popularity has shifted from massive time-sharing systems to client server architectures, to various strategies for distributed processing, and more recently to peer-to-peer interactions over the Internet.

In some areas, available methods for creating and handling complex systems have not kept up with the evolving complexity of those systems. Many tools, designed for single users operating dedicated computer systems, have not evolved to full functionality in an environment of interactive autonomous processes.

An example is found in the field of tools for testing complex software applications, or other processing applications such as programmed applications instantiated in hardware.

Sophisticated tools are available for testing and evaluating single-user applications. The WINRUNNER program marketed by Mercury Interactive is an example of such a local script based tester. WINRUNNER provides input to an interactive process, thereby simulating the providing of input to that process by a human user. WINRUNNER also monitors the consequent output of that process, output normally intended for a human user. By comparing actual output to expected output WINRUNNER provides useful test analyses, in particular by pointing out input/output sequences in which the tested software application has not behaved as expected. By varying the content, quantity and timing of the input, WINRUNNER can test the application's behavior over a broad variety of situations.

Input intended for the tested application system, and output expected from the tested application system, are typically provided in the form of “scripts”, mini-programs specifying what input is to be sent to a process, the circumstances under which it is to be sent, and the output expected to result from the application's processing of the provided input. This testing process is called “functional testing”. WINRUNNER is a leading example of the genre.

A particular enhancement of functional testing is “regression testing”, which may also be accomplished using WINRUNNER and similar programs. In regression testing, the output of a new version of a software application is compared to the output of an older version of the same software application, under an identical set of input, the input being provided by WINRUNNER or by a similar testing program. Regression testing is typically used to verify that the established functionality of a processing application, such as a software application, has not been damaged during the development of some improved or added functionality in the application.

WINRUNNER is primarily designed for testing single-user single-process applications. Similar tools exist for testing and evaluating multi-station systems, and in particular for testing large networked or time-shared multi-user interactive software applications. LOADRUNNER, also marketed by Mercury Interactive, is an example of such a multi-point script-based load evaluator. LOADRUNNER has the ability to manage the execution of WINRUNNER scripts on a plurality of remote networked processors, thereby providing a simulation of simultaneous or nearly-simultaneous use of a complex application system by a large number of (simulated) users.

To accomplish such remote testing of multiple users, LOADRUNNER operates processes running on a plurality of processors in a manner almost identical to the manner in which WINRUNNER operates a tested software application running on a dedicated single-user computer. WINRUNNER provides simulated human input (or simulated input from a remote digital source) to a process, and monitors the output produced by the process. LOADRUNNER does the same, differing from WINRUNNER principally by the fact that LOADRUNNER provides input to a plurality of processes rather than to a single process, and monitors output from a plurality of process rather than a single process.

LOADRUNNER has, however, a serious limitation. LOADRUNNER's scripting (programming) language and scripting capabilities are substantially similar to those of WINRUNNER, in that the script-based conditions for providing input to a process are generally limited to decisions based on output of that same process. That is, the scripting (programming) capabilities of LOADRUNNER for describing the conditions for providing particular input to a particular process “X” running in the context of a multi-station application are substantially limited to consideration of information contained in, or information about, specific outputs of that same particular process X. Because of this limitation, the utility of LOADRUNNER and similar programs, for testing a multi-station application having a plurality of processes some of which interact with each other, is severely curtailed.

The single exception to this limitation in LOADRUNNER capabilities is found in the LOADRUNNER “rendezvous point” concept. Using rendezvous point commands, a set of processes can be commanded to wait for each other to terminate an identical operation before any of the processes of that set of processes is allowed to proceed beyond that operation. The rendezvous point command is typically used to force a plurality of similar or identical processes to an identical stage of operation, before proceeding with succeeding stages of operation, and is useful for testing the load-bearing capabilities of system architectures under conditions of high demand and limited resources. Yet the rendezvous command is not a command for creating dependence of an operation in one autonomous process upon the execution of a different operation in another process. Rather, it is explicitly an expression of a mutual dependence among a set of processes. As such, its use as a tool for coordinating and/or testing the activities of mutually interrelating autonomous processes is extremely limited.

LOADRUNNER contains methods for conditional execution of deliveries of input for a process based on the timing, content, or quality of output from that same process, yet does not contain methods for conditional execution of deliveries of input for a process based on the timing, content, or quality of output from other independent processes within the same overall multi-station processing. Therefore, LOADRUNNER is unable to test interdependencies between and among the individual processes to any substantial extent.

Thus, just as WIRUNNER is appropriately designed for single-user single-process testing, so LOADRUNNER is appropriately designed for massive parallel testing of large numbers of individual semi-autonomous processes which run in parallel and which, other than sharing processor, communications, or memory resources, have very little to do with one another. Indeed, historically LOADRUNNER was developed precisely to test those aspects of multi-user multi-station systems having to do with problems encountered when multiple inputs, whether by their nature are by their sheer quantity, make high demands on limited processing, communications, and memory resources.

The above limitation in testing integrated functionality must be considered in the light of situations frequently encountered in the multi-user multi-station systems of today, wherein multiple processes having multiple interactive functional relationships with each other are the rule rather than the exception. LOADRUNNER and similar programs are fundamentally ill equipped to deal with applications wherein outputs to be expected from one process are properly dependant on inputs to, or outputs from, other processes possibly running on other processors within a networked plurality of otherwise autonomous processes. Neither WINRUNNER nor LOADRUNNER can adequately test application systems such as these. They are not designed to handle, nor do they well handle, situations arising from the interdependence of autonomous processes.

An example illustrating the problem is provided by a multi-user multi-station software application in the form of an email system. Station A sends mail to station B. WINRUNNER, or a WINRUNNER-type script running under control of LOADRUNNER, can provide input to station A adequate to create an email letter, and, by monitoring output from station A can verify that station A appears to have received the input from the simulated user, and appears to have sent the mail. Another instance of WINRUNNER, or a WINRUNNER-type script running under control of LOADRUNNER, can verify that station B appears to have received an email. LOADRUNNER, utilized in typical fashion, can ascertain whether, when 100 stations send nearly simultaneous emails to 100 other stations on the system, successful email transmissions appear to take place without system failure and in reasonable time. Yet neither WINRUNNER nor LOADRUNNER are designed nor intrinsically equipped to monitor the quality of the intra-active aspects of this process. The WINRUNNER process monitoring station B does not know when to start looking for an email from station A, nor when, nor whether, that email was sent.

Worse yet, if a process in Station A is dependent for execution on a process in Station B, and the process in Station B is dependent for execution on a process in Station A, neither WINRUNNER nor LOADRUNNER is equipped to diagnose and handle this situation. If Station B is programmed to await a data-containing email from station A, and after receiving that email is programmed to send a confirmation email to station A, yet station A has been programmed to await a data request from station B before sending the expected data-containing email to station A, then each station will wait for input from the other before performing its programmed operation, consequently neither station will do anything.

If continued functioning of the application is dependant on termination of this process, then the application as a whole may be freeze. Such an interlocking incompatible interdependency is typical of the kind of design mistake or programming mistake that tools for testing intra-active multi-process multi-user software applications must discover and handle. Yet, neither LOADRUNNER nor WINRUNNER nor a combination of the two will in fact handle this situation elegantly and effectively. What does happen under WINRUNNER/LOADRUNNER when a tested application has the above mentioned design or programming problem or incompatibility is, unfortunately, that not only will the application (or some of its assets) freeze, but in many cases the WINRUNNER or LOADRUNNER testing system will freeze as well.

Further, since the WINRUNNER/LOADRUNNER testing system is not designed to handle the above sort of problem, debugging facilities are primitive or completely absent, and the user is provided with little information as to the source of the problem and little help in fixing it. What little debugging facilities there are, are operable only at the level of a central controller controlling all of the processes. The debugging facilities are not operable at the level of the individual script controlling an individual process.

As a further example of a situation difficult or impossible to test under the WINRUNNER/LOADRUNNER prior art technologies, consider a software testing system required to test the following sequence in a three-station application system:

Station A goes through an initialization procedure, does a calculation on a set of data, then sends a calculated result to station C.

Station B also goes through an initialization procedure, also does a calculation on a set of data, and also sends a calculated result to station C.

Station C waits until it receives a calculation result, either from station A or from station B, and then immediately proceeds to calculate a final result.

In this example, testing of output from station C must be coordinated with the progress of the calculation activities of stations A and B. Attempting to check the result of the calculations in station C at a time when station C has not yet received information from A and B on which to base its calculation will result in failure, not because the calculation process is defective, but because of a failure of proper synchronization in the testing system.

Yet software testing tools do not typically have access to network events within the application system being tested. WINRUNNER and LOADRUNNER, for example, are designed and constructed to interact with tested applications merely by sending to them input data as if from a keyboard or other simulated input device, and by receiving output data by reading and interpreting graphic output sent by the application to a real or simulated display device. Coordinated testing of activities on stations A, B and C therefore requires a source of sequencing information, for telling the testing tool what events to process and in what order, what outputs to check, when to check them, and what results should be expected on which stations of a multi-station system.

“Rendezvous point” technology, the only synchronizing technology available in the WINRUNNER/LOADRUNNER prior art system, cannot test this process, because it does not provide a way to make testing in station C temporally dependent on an event which might occur either in station A or in station B.

Rendezvous point techniques can, of course, be used to make testing activities in station C dependant on an identically-defined event in both stations A and B, using the following set of scripts:

Station A:

DoInitialCalculation ( )

SendCalculatedResult ( )

Rendezvous (1)

Station B:

DoInitialCalculation ( )

SendCalculatedResult ( )

Rendezvous (1)

Station C:

Rendezvous (1)

ReceiveInitialCalculationResult ( )

DoFinalCalculation ( )

Yet, the solution provided by the above scripts is far from optimal. In the best case, testing and the application itself would be delayed while waiting unnecessarily for the completion of both calculations, rather than only the single completed calculation required by the application. In the worst case, this use of the rendezvous point could lead to a total failure of the test. So far as the application itself is concerned, failure of one of the calculations ever to complete might be a perfectly legitimate and expected outcome under some intended uses of the calculations in a given application. Yet, so far as the testing process is concerned, failure of one of the calculations to complete, while using rendezvous points to synchronize testing in station C with completion of calculations in stations A and B, would cause the testing program itself to fail to complete its operation as well.

An additional limitation of the prior art “rendezvous point” technology is found in the fact that the rendezvous point is designed to synchronize processes on a plurality of stations by waiting until an identical output state has been identified in each of the plurality of stations. Therefore, the rendezvous point technique cannot be used to order processes which do not influence the output state of one of the plurality of stations. Consider for example a testing program being required to test the behavior of a system when station A sends a message to a station C, and subsequently station B sends a message to station C. Unless the sending of the message by station A influences the output of station B, there is no way to use using rendezvous point technology to cause a testing script controlling the activities of station B to cause station B to send its message at an appropriate time, since stations A and B have no common output event for which they can be instructed to wait.

An additional limitation of the prior art “rendezvous point” technology is that in many cases sequencing of testing events can be accomplished by rendezvous points only by introducing unnecessary wait states into the tested processes, which not only makes the testing process inefficient, but also distorts the natural operation of the system being tested. Consider for example a situation in which a station A is required to send a message to a station B and then execute a set of internal tests, and station B is required to do internal tests and then receive the message from station A. Rendezvous point technology enables the sequencing of these events using the following pair of scripts:

Station A:

SendMessageToStationB ( )

Rendezvous (1)

DoInternalTestsInStationA ( )

Station B:

DoInternalTestsInStationB ( )

Rendezvous (1)

ReceiveMessageFromStationA ( )

The above pair of scripts will indeed sequence the activities of the stations such that station B will appropriately attempt to read the message from station A only after that message has been sent by station A. However, the above scripts necessarily cause an undesirable and abnormal wait state in station A. Station A would normally (that is, when the application is running normally and not under control of the testing script) sent its message to station B and then proceed immediately to the executing of its internal tests. Under control of the above scripts, the use of the rendezvous point forces station A to wait until after station B has completed its internal tests, before the internal tests of station A can begin.

An alternative script for station B accomplishes the sequencing differently, but not more successfully:

Station B:

Rendezvous (1)

DoInternalTestsInStationB ( )

ReceiveMessageFromStationA ( )

Under this alternative script for station B, no undesirable wait state is created in station A, since station A is enabled to proceed to its internal tests as soon as its message to station B has been sent. However, an equally undesirable wait state is created in station B. since the rendezvous point forces station B to wait unnecessarily until after the message has been sent from station A before station B is enabled to begin its internal testing sequence.

In a further example of a problem difficult to solve using rendezvous point technology, it is desired for a station B to receive a first input set if an event in station A completes successfully, and to receive a second input set if that event in station A completes unsuccessfully. The prior art WINRUNNER/LOADRUNNER script system provides no tools for informing station B of the status of an event in station A. A partial solution might be forced, if stations A and B had common access to a network disk or similar resource, by causing the script from station A to write a results file to that common disk and causing the script of station B to read the file, but such a solution is awkward at best, and is not possible in cases where stations A and B do not have access to a common disk, as is often the case. The WINRUNNER/LOADRUNNER script language itself provides no direct tools for solving this problem.

In general, the more an application has multiple interactive dependencies among processes and among stations, the less such an application can conveniently be tested using only “rendezvous point” technology for coordinating activities across the plurality of stations.

It may also be noted that even in cases where interdependent multi-process applications could theoretically be tested by pushing “rendezvous point” technology to its limits, for example by utilizing large numbers of specific rendezvous points and using careful planning and thorough and careful record-keeping to carefully sequence hundreds of individual events one with reference to the others and maintaining consistency in the use of rendezvous points across the entire application, such a solution is unwieldy or impractical in practice. Such a solution requires a high degree of systematic knowledge on the part of the tester over the entire breadth of the application, and such breadth of knowledge is not typical of the personnel typically employed to plan and execute quality assurance software testing. Moreover, even an experienced tester with expert knowledge of the application system can easily find that he has unknowingly constructed a test in which, under some given set of circumstances, a process in first station can't continue because it is waiting for a rendezvous point event in a second station, while the process of the second station can't continue because it is waiting for a rendezvous point event dependant on completion of some event in the first station. Prior art tools give no help in debugging such a situation.

A further disadvantage of the prior art WINRUNNERILOADRUNNER rendezvous point synchronization technique is that execution of synchronization utilizing this technique is dependant on the existence and utilization of a common controller communicating with each of the participation stations, to monitor and control their processes. That is, the WINRUNNER/LOADRUNNER testing system does not incorporate a synchronization methodology accessible at the level of the individual station, but only at the level of a controller controlling all stations. As a result of this limitation, it may be awkward and difficult to experiment with minor changes in the synchronization among a small subset of stations within a large general application, since a tester must intervene at the level of a script controlling a test of the entire application. In the case of applications running on tens or hundreds of stations, such an intervention is complex and time-consuming, and it would be preferable, both for the development, maintenance, and debugging of scripts and for the debugging of multi-station applications, to enable the tester to intervene at the level of scripts controlling individual stations or a small subset of the plurality of stations involved in running the multi-station application, yet still be able to control synchronization of activities among that subset of stations.

Thus, the writing of testing scripts using rendezvous points to achieve the required synchronization, even when possible, is prohibitively complex and generally unsatisfactory. Not only are such scripts necessarily inefficient and subject to unpredictable failure, as shown above, but they are also inconvenient to write, difficult to debug, and almost impossible to maintain.

These and other examples demonstrate the inadequacy of WINRUNNER and LOADRUNNER for testing multi-station intra-active software application systems.

Similar conditions obtain with respect to other tools known in the art, such as tools competitive with Mercury Interactive products in the field of software application testing. Rational Software, for example, markets tools which enable delaying the execution of an entire test (an entire script) on one station until after the execution of another entire test (entire script) on another station, but Rational's tools provide no facilities for organizing timing dependencies or logical dependencies among processes running on different stations within the context of a mutual test, hence Rational's tools are not appropriate for testing an integrated operation running on a plurality of applications. In general, inspection of such programs as LiveQuality and SilkTest from Segue, QARun, QADerector, QACenter, TestPartner, QAHiperstation, QAHiperstation+ and QALoad of Compuware Corporation, TETware professional of The Open Group, SQA Center, Rational Suite TestStudio, Rational TestManager, Rational TeamTest and Rational SiteLoad of Rational Software Corp., reveal that none of these tools can adequately test the intra-active aspects of multi-user or multi-station systems. Each lacks at least some of the following:

1. the ability to adequately define a multi-station test,

2. the ability to run a test on a remote station,

3. the ability to gather results from a plurality of tests on a multi-station system into a single report,

4. the ability to adequately specify and control temporal relationships in the execution of scripts running on a plurality of stations,

5. adequate tools for debugging problems arising from the interactive relationships of semi-autonomous processes in a station context, and

6. adequate tools for debugging problems arising from the testing of such systems.

Thus there is a need for, and it would be highly advantageous to have, a system and method for testing multi-station intra-active software application systems, and in particular for testing the intra-active aspects thereof.

WINRUNNER is an example of a competent tool designed and constructed for accomplishing a particular purpose with respect to a single-process computer application, yet WINRUNNER is not adequate for fulfilling a similar function with respect to a multi-station system. Similar situations exist in other areas, where software appropriate for a particular function in a single-user or single-process environment could be adapted to wider user in a multi-user multi-station environment, but in fact has not been so adapted.

Thus there is a widely felt need for, and it would be highly desirable to have, a system and method for joining autonomous software modules, designed for independent and autonomous activity, into integrated multi-module functional systems, by providing a linking system for organizing their mutual activities by controlling the flow of data among them.

### SUMMARY OF THE INVENTION

According to one aspect of the present invention there is provided an apparatus and method for running an integrated operation on a plurality of applications distributed on networked stations, and further relates to use of such apparatus and method for integrated testing of such a plurality of applications.

The present invention addresses the shortcomings of the presently known configurations by providing apparatus and method for creating integrated functionality in systems comprising a plurality of applications distributed on networked stations, particularly for autonomous processing units originally designed and constructed for autonomous activity and not for integration within such a multi-module system.

The present invention further addresses the shortcomings of the presently known configurations by providing apparatus and method for testing the integrated operation of a plurality of applications distributed on networked stations.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

According to a first aspect of the present invention there is provided a supervisor apparatus for running an integrated operation on a plurality of applications distributed on networked stations, the apparatus comprising: an evaluating unit for receiving and evaluating output from at least two stations including a first station and at least one other station, and an operating unit for sending selected commands to a first application running on said first station, said commands being selectable according to rules, said rules specifying a dependency of a command to be sent to said first station upon an evaluation of output from said at least one other station.

Preferably, the rules are embodied in a computer program, or are scripts.

Preferably the rules comprise a synchronization point comprising a requirement for unidirectional temporal dependency of a command to one station upon received outputs from said other station.

The operating unit may be a process running on the first station, or on a station other than the first station.

Preferably, the apparatus is designed and constructed for sending commands to a plurality of applications running on a plurality of stations.

Preferably, the apparatus is designed and constructed for testing the applications, including functional testing and regressive testing.

The apparatus may comprise a testing unit for testing the integrated operation. Preferably the apparatus comprises a functional testing unit for functional testing of said integrated operation, and a regressive testing unit for regressive testing of said integrated operation.

The integrated operation may be a test operation, and may comprise functional tests on the applications, and regressive tests on the applications.

Alternatively, the distributed applications may be test applications operative to test locally installed test subject applications, and may comprise at least one of a group comprising functional testing ability and regressive testing ability.

Preferably, the rules comprise scripts for interacting with a plurality of applications. The interaction may be a test.

Preferably, the supervisor apparatus is operable to freeze running of the scripts at at least one of the applications until receipt of a predetermined output from a predetermined other of the applications.

Preferably, the supervisor apparatus is operable to freeze running of the scripts at at least one of the applications until receipt of an indication that a predetermined other of the applications is ready to carry out a given operation.

Preferably, the supervisor apparatus comprises a synchronization point definer operable to define synchronization points in the integrated operation, the synchronization points being usable at a station to temporally affect operation at that station.

Preferably, the synchronization point definer is operable to include, with the synchronization point, a definition comprising a list of at least one station to use the synchronization point.

Preferably, the synchronization point definer is also operable to include, with the synchronization point, a definition comprising a list of at least one station to respond thereto in a first way and a list of at least one station to respond thereto in a second way.

Preferably, the synchronization point definer is operable to include, with the synchronization point, a definition comprising at least two events from evaluations made by the evaluator. In a preferred embodiment, at least one of the two events is an evaluation of output from the first station and at least one of the two events is an evaluation of output from the second station. Preferably, the synchronization point definer is operable to include, with the synchronization point definition, a list of at least one station to react to a first of the events and at least one station to react to at least a second of the events. The first event may comprise an indication of successful sending of data from a first station and the second event an indication of successful receipt of said data at a second station. Alternatively, the first event may comprise an indication of successful sending of data from a first station and the second event an indication of unsuccessful receipt of the data at a second station.

Preferably, the synchronization point definer is operable to define, for at least one station, a maximum time delay for waiting for an event associated with the synchronization point.

Preferably, the synchronization point definer is operable to define different maximum time delays for different stations.

An embodiment of the supervisor apparatus further comprises an event occurrence notifier operable to inform one of said stations about occurrence of an event at another of said stations, and is operable to include supervisor generated data regarding the occurrence, or station generated data regarding the occurrence.

Preferably, the evaluating unit of the supervisor apparatus is operable for evaluating output from at least two stations together.

According to a second aspect of the present invention there is provided a system for running an integrated operation on a plurality of applications distributed on networked stations, the system comprising a plurality of supervisor apparatus units for running an integrated operation on a plurality of applications distributed on networked stations, at least one of the supervisor apparatus units comprising an evaluating unit for receiving and evaluating output from at least two stations, including a first station and at least one other station, and an operating unit for sending selected commands to a first application running on said first station, the commands being selectable according to rules, the rules specifying a dependency of a command to be sent to the first station upon an evaluation of output from at least the other station, and a coordinator for coordinating operation of said plurality of supervisor apparatus.

Preferably, the coordinator is operable for sending parameters to the supervisor apparatus, for affecting operation of the rules.

Preferably, the coordinator is operable for sending sets of rules to the supervisor apparatus, for use by the supervisor apparatus in running integrated operations on a plurality of applications distributed on networked stations.

Preferably, the sets of rules are for testing the applications, the testing preferably comprising functional tests and regressive tests.

In a preferred embodiment the sets of rules are for testing the integrated operation, and comprise functional tests and regressive tests.

Preferably, the coordinator comprises a logging unit for collecting and recording output from at least some of the networked stations.

Preferably, the coordinator comprises a report generator, associated with the logging unit, for generating reports based on the collected output.

Preferably, the report generator comprises a summarizer for summarizing the collected output, and a describer for evaluating and characterizing the collected output.

According to a third aspect of the present invention there is provided a test apparatus for running on a first station to test an application thereon, the test to be integrated with tests on remotely located other stations networked therewith, the apparatus comprising an operating unit for sending selected commands to the application, the commands being selectable according to rules, the rules specifying a dependency of a command to be sent to the application upon an evaluation of output at least one of the remote stations, and an evaluator, associated with the operation unit, for selecting commands to be sent to the application according to an evaluation of outputs received from the remote stations, the evaluation being dependent on the rules, thereby to control flow of the commands locally at the first station in accordance with the outputs received from the at least one remote station. In a preferred embodiment, the first station is a remote station.

Preferably, the rules comprise synchronization at predetermined synchronization points.

Preferably, the rules are suppliable to the operating unit by a remote coordinator.

Preferably, the test comprises functional tests on the application, and regressive tests on the application.

In a preferred embodiment, the outputs comprise the results of test scripts run by each test application, and the evaluator is operable to freeze running of a respective test script until receipt of a predetermined output from a predetermined other of the applications.

In a preferred embodiment, the outputs are the results of test scripts run by each test application, and the evaluator is operable to freeze running of a respective test script until receipt of an indication that a predetermined other application at a remote station is ready to carry out a given operation.

According to a fourth aspect of the present invention there is provided a supervisor method for running an integrated operation on a plurality of applications distributed on networked stations, the method comprising sending selected commands to at least one application of the plurality of applications, the application running on a first station, receiving and evaluating output from the at least one application and from at least one other station, and selecting commands for sending to the application, the selection being dependent on rules, the rules specifying a dependency of a command to be sent to the first application upon an evaluation of output from the other station.

Preferably, the integrated operation is a test operation comprising functional tests on the applications and regressive tests on the application.

Alternatively, the distributed applications may be test applications operative to test locally installed test subject applications.

Preferably, the distributed applications comprise at least one of a group comprising functional testing ability and regressive testing ability.

Preferably, the rules comprise a synchronization point comprising a requirement for unidirectional temporal dependency between a command on one station and received outputs from another station.

A preferred embodiment further comprises utilizing a synchronization point definer to define synchronization points in the integrated operation, the synchronization points being usable at a station to temporally affect operation at that station.

Preferably, the method further comprises utilizing a synchronization point definer to define a synchronization point in the integrated operation, the synchronization point being usable at a plurality of the stations to temporally affect operation at a selected ones of the stations.

Preferably, the method further comprises utilizing the synchronization point definer to define, with said synchronization point, a list of at least one station to use the synchronization point.

Preferably, the method further comprises utilizing the synchronization point definer to define, with the synchronization point, a list of at least one station to respond thereto in a first way and a list of at least one station to respond thereto in a second way.

Preferably, the method further comprises utilizing the synchronization point definer to define, with the synchronization point, a list of at least two events from the evaluation.

Preferably, the method further comprises utilizing the synchronization point definer to define, with the synchronization point, a list of at least one station to react to a first of the events and a list of at least one station to react to at least a second of the events. The first event may comprise an indication of successful sending of data from a first station and the second event an indication of successful receipt of said data at a second station. Alternatively, the first event may comprise an indication of successful sending of data from a first station and the second event an indication of unsuccessful receipt of the data at a second station.

Preferably, the method further comprises defining, for at least one station, a maximum time delay for waiting for a synchronization event associated with the synchronization point. A preferred embodiment comprises defining different maximum time delays for different stations.

In a preferred embodiment, the outputs comprise the results of test scripts run by each test application. Preferably, the method comprises freezing running of a script at a first application until receipt of a predetermined output from a predetermined other of the applications, and freezing running of a script at a first application until receipt of an indication that a predetermined other of the applications is ready to carry out a given operation.

In a preferred embodiment, the method further comprises informing any one of the stations about occurrence of an event at any other of the stations. Preferably the notification includes supervisor generated data regarding the occurrence, and station generated data regarding the occurrence.

In a preferred embodiment, the method further comprises debugging in accordance with output from at least one of the stations.

According to a fifth aspect of the present invention there is provided a testing method for testing an integrated operation running as a plurality of applications distributed on networked stations, the method comprising

sending selected commands to at least one application of the plurality of applications, the application running on a first station, receiving and evaluating output from the at least one application and from at least one other station,

selecting commands for sending to the application, the selection being dependent on rules, the rules specifying a dependency of a command to be sent to the first application upon an evaluation of output from the other station, comparing the received output to a body of expected output, and reporting differences between the received output and the expected output, thereby testing whether the received output conforms to expectations.

Preferably, the comparison of said received output to the body of expected output comprises a functional test of the integrated operation and a regressive test of the integrated operation.

Alternatively, the comparison of the received output to the body of expected output comprises a functional test of at least one application and a regressive test of at least one application.

BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, not attempt is made to show structural details of the invention in more detail than is necessary for a fundamental understanding of the invention, the description taken with the drawings making apparent to those skilled in the art how the several forms of the invention may be embodied in practice.

In the drawings:

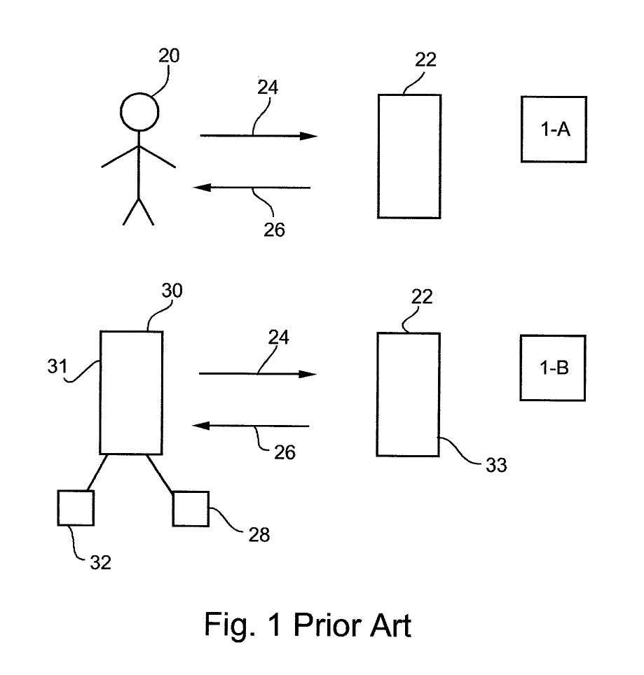

FIG. 1 is a schematic showing a supervisor apparatus operating an application, according to methods of prior art,

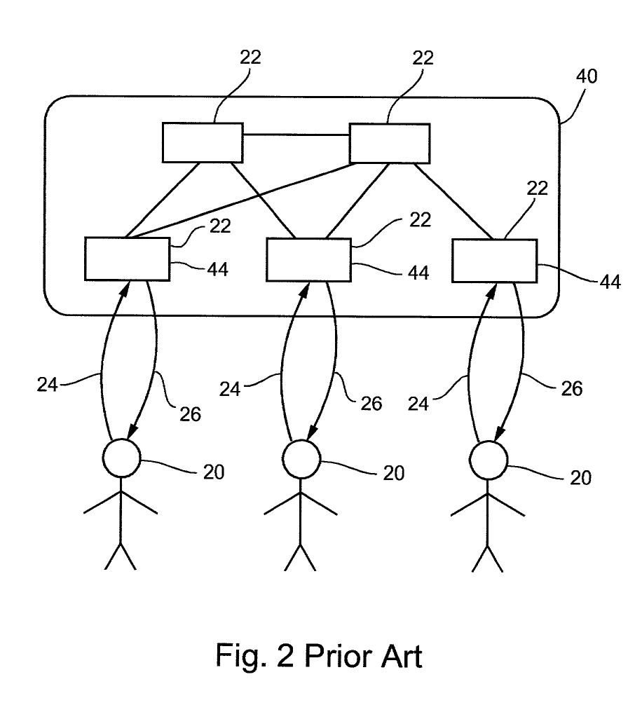

FIG. 2 is a schematic showing patterns of interaction between a plurality of users and an integrated operation on a plurality of applications distributed on networked station including a plurality of input/output application terminals, according to methods of prior art,

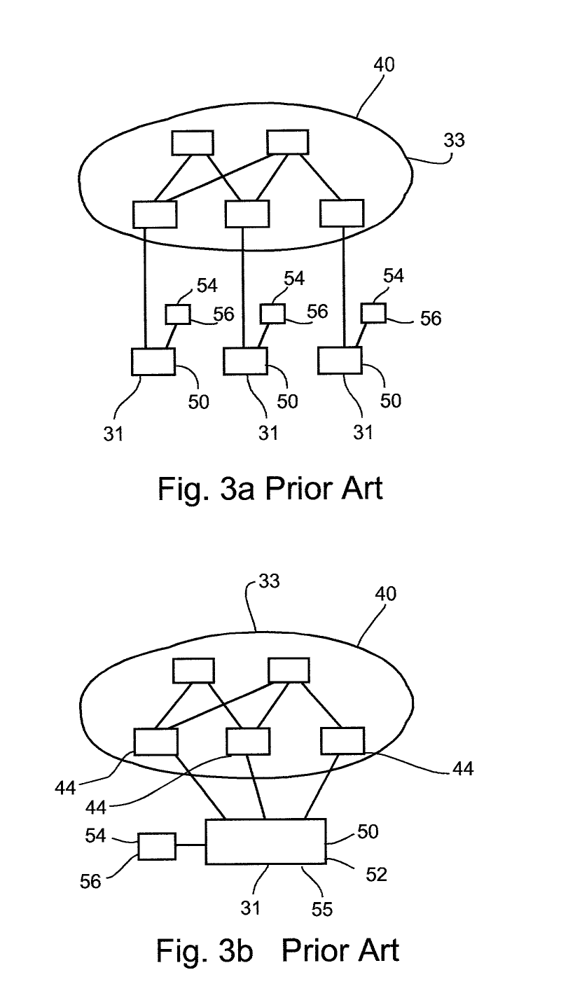

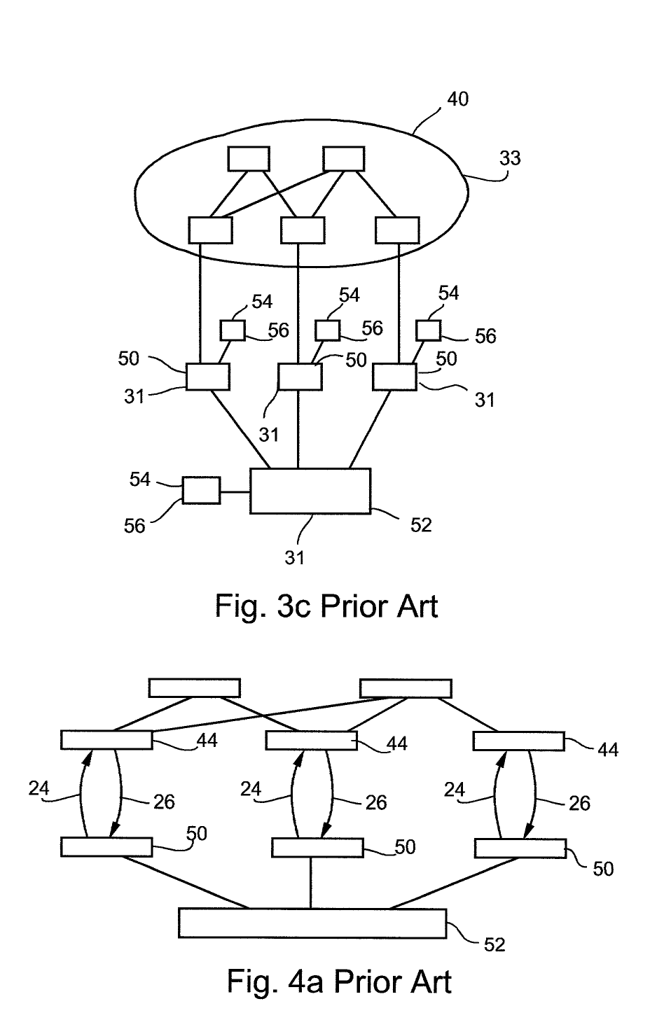

FIG. 3 is a schematic showing alternate structures for a supervisor apparatus designed for testing operation of a plurality of applications distributed on networked stations, according to methods of prior art,

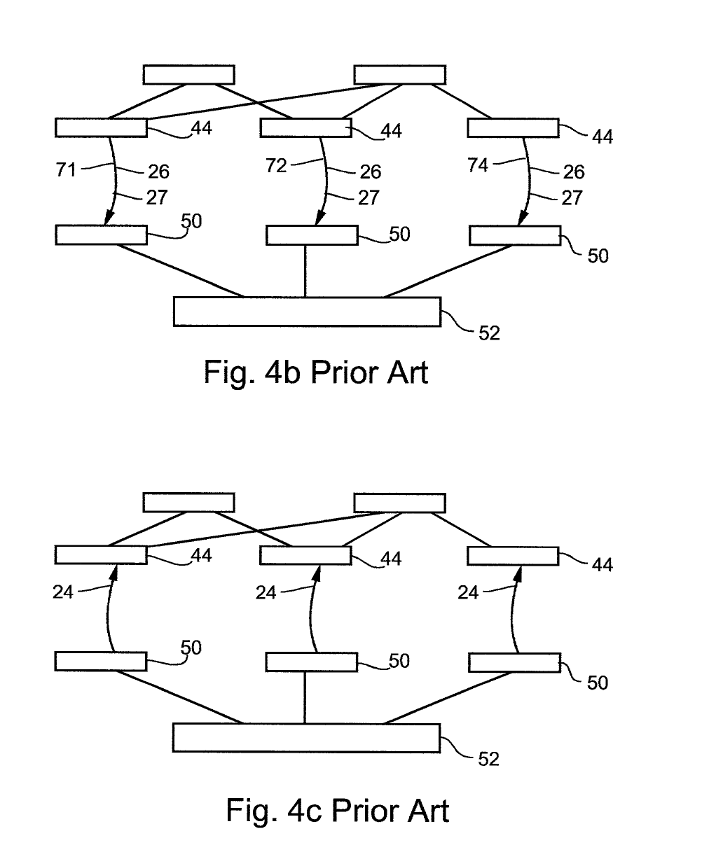

FIG. 4 is a schematic showing patterns of interaction between a supervisor apparatus and a plurality of applications distributed on networked stations, according to methods of prior art,

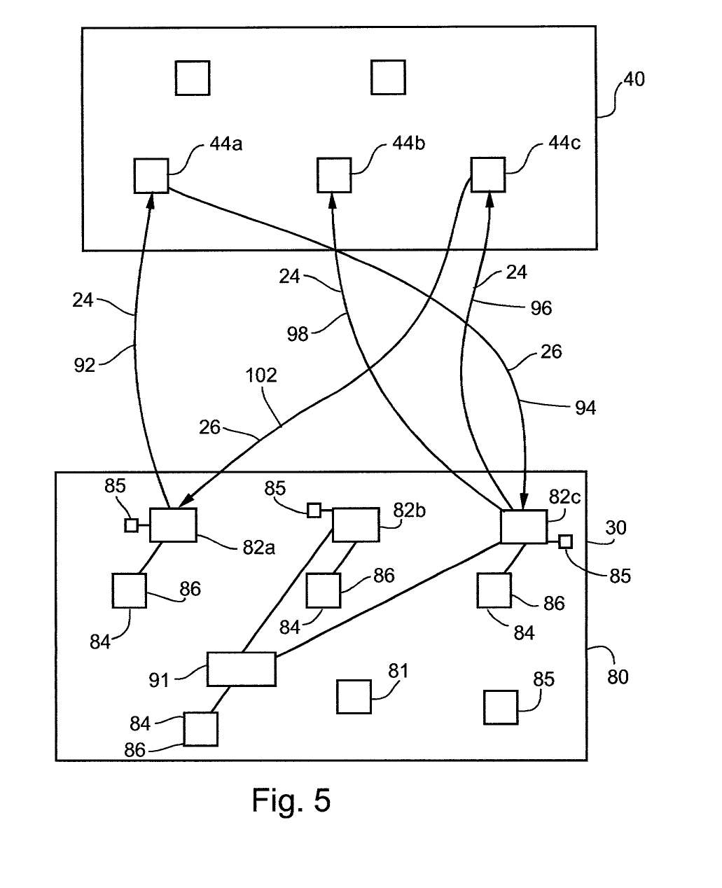

FIG. 5 is a schematic showing patterns of interaction between a supervisor apparatus and a plurality of applications distributed on networked stations, according to an embodiment of the present invention,

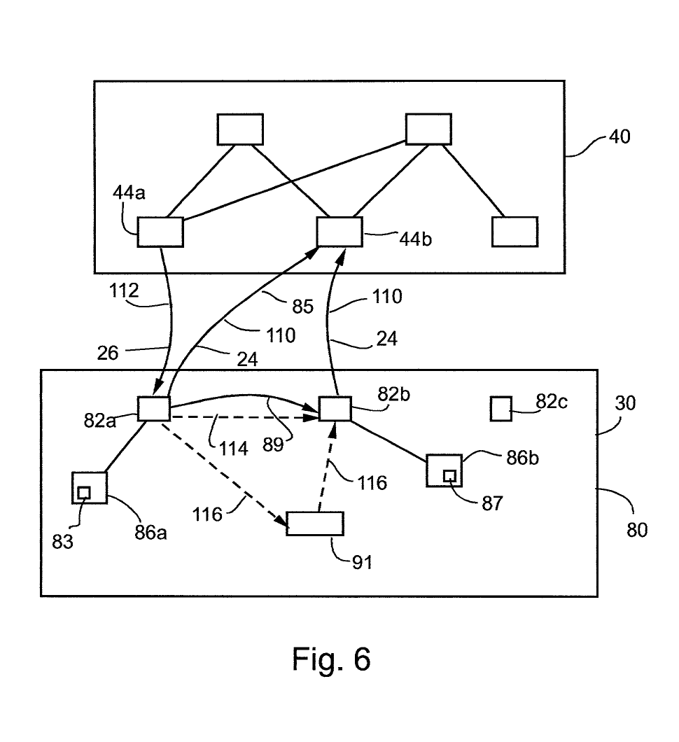

FIG. 6 is a schematic showing an exemplary sequence of interactions between a supervisor apparatus and a plurality of applications distributed on networked stations, according to an embodiment of the present invention,

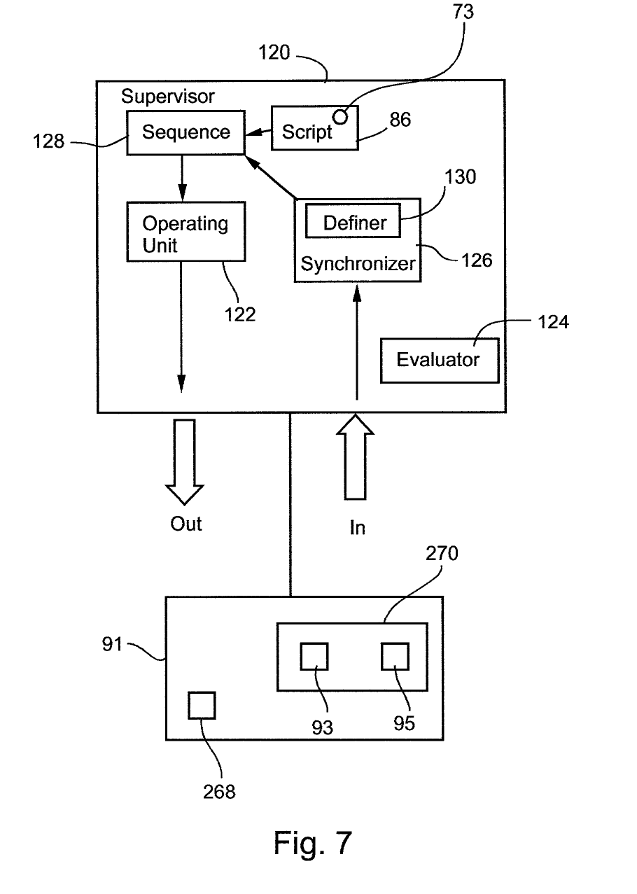

FIG. 7 is a simplified diagram of a supervisor unit according to an embodiment of the present invention,

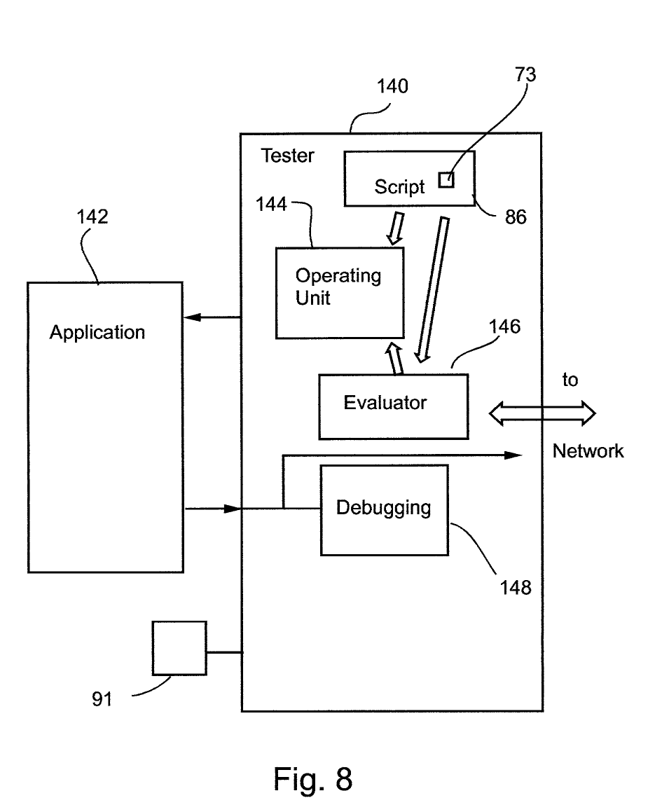

FIG. 8 is a simplified diagram of an application unit according to an embodiment of the present invention,

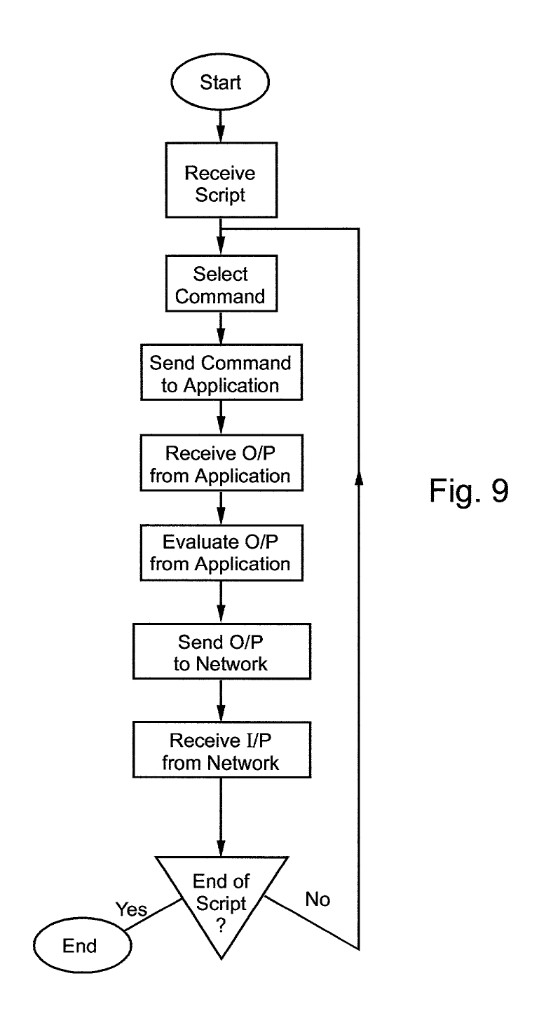

FIG. 9 is a simplified flow chart showing operation of an individual testing unit being controlled by a supervisory device,

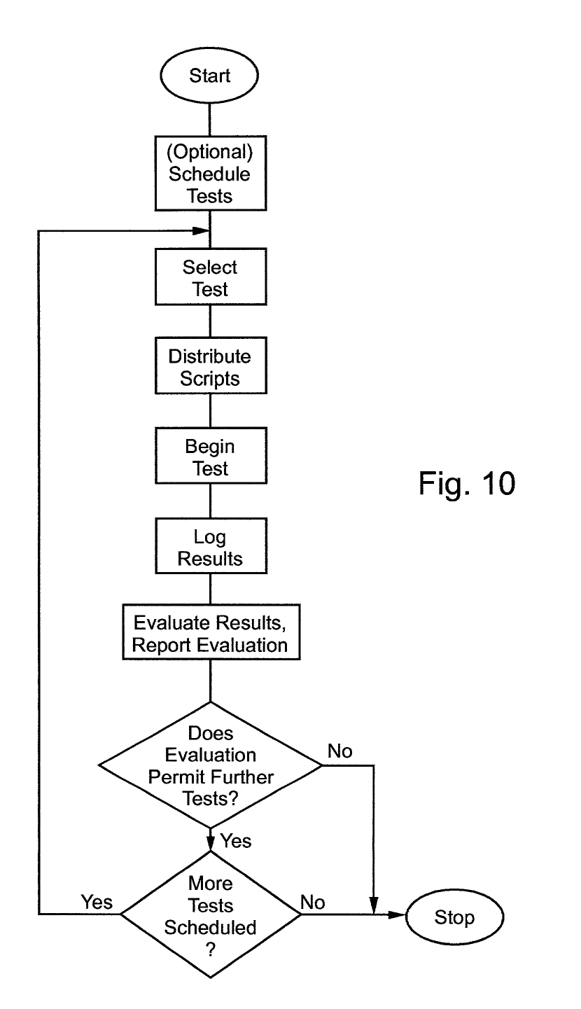

FIG. 10 is a simplified flow chart showing a supervisory method according to an embodiment of the present invention from the point of view of a supervisory device,

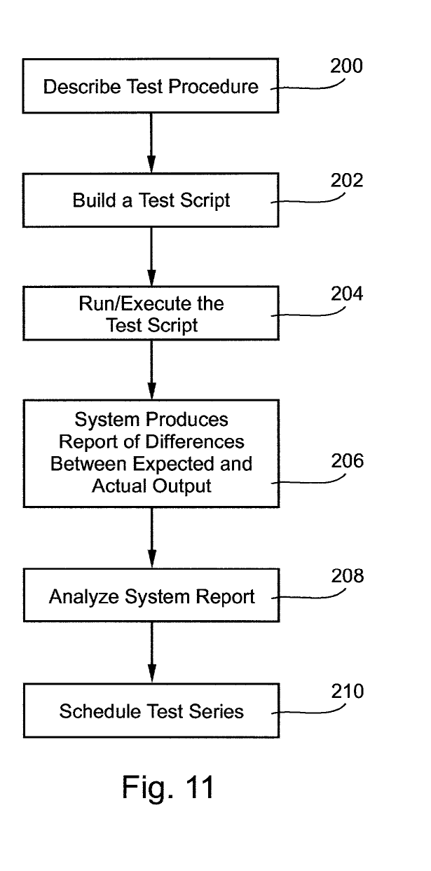

FIG. 11 is a simplified flow chart describing a preferred method for running a multi-station test on a plurality of stations, according to an embodiment of the present invention,

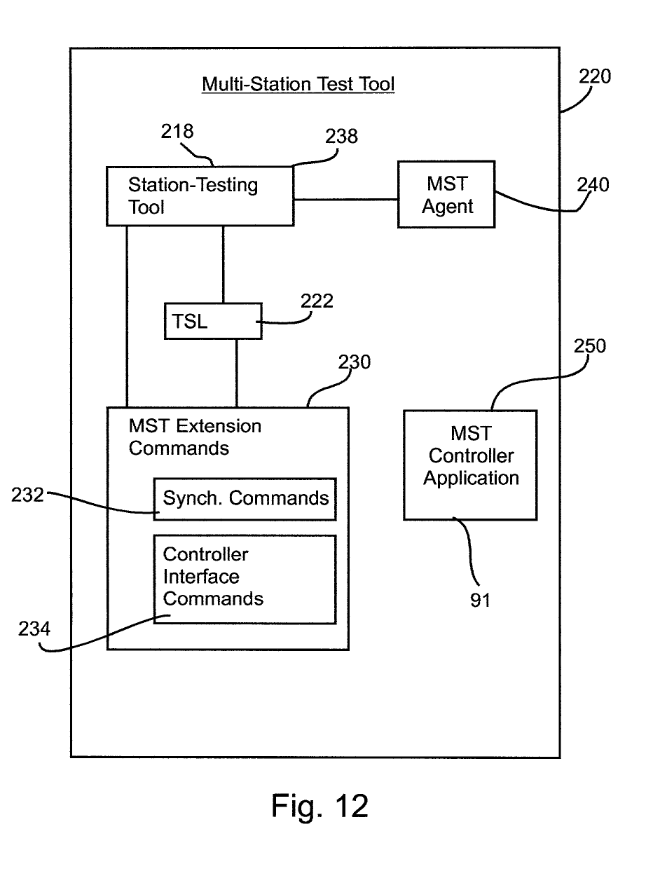

FIG. 12 is a simplified block diagram of a tool for executing multi-station tests, according to an embodiment of the present invention,

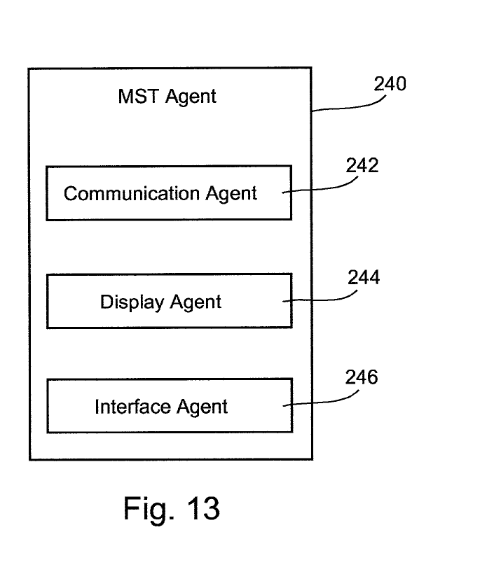

FIG. 13 is a simplified block diagram of a tool used for running multi-station tests on a station, according to an embodiment of the present invention,

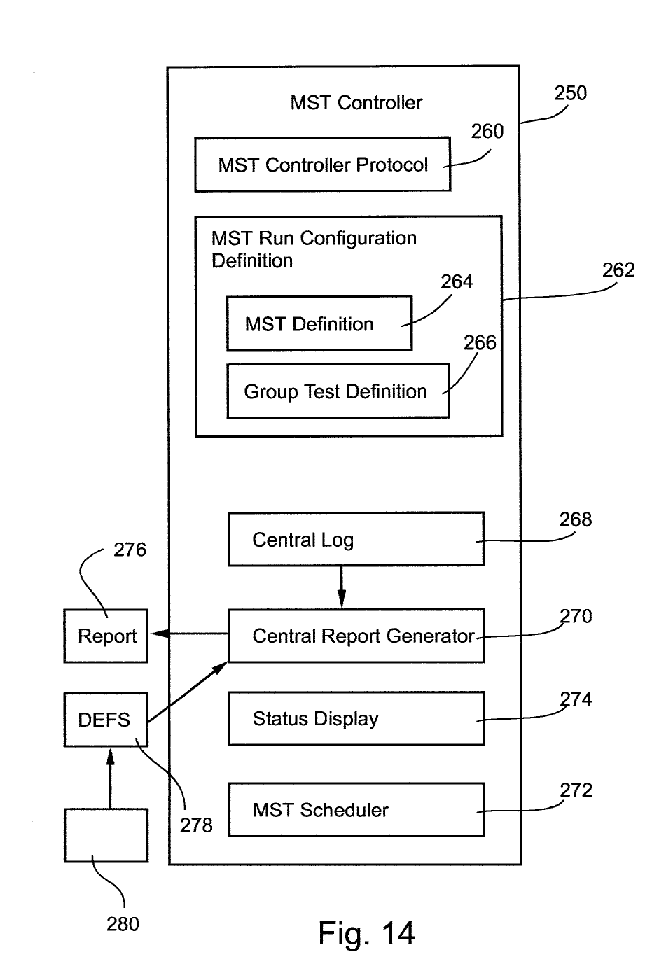

FIG. 14 is a simplified block diagram of a tool used for running multi-station tests on a plurality of stations, according to an embodiment of the present invention,

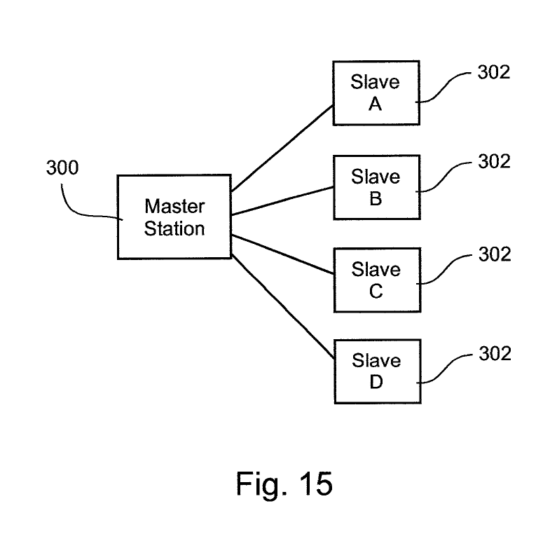

FIG. 15 is a simplified block diagram of a hierarchical application system, useful in describing the operation of an embodiment of the present invention, and

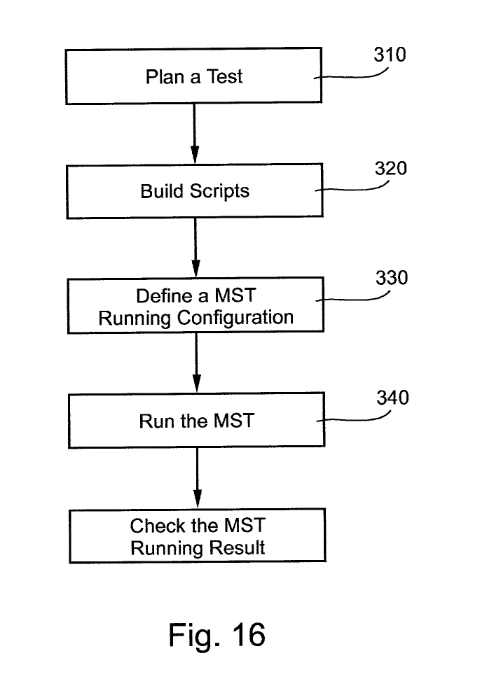

FIG. 16 is a simplified flow chart presenting recommended steps of a procedure for testing the hierarchical system of FIG. 15, according to a preferred embodiment of the present invention.

### DESCRIPTION OF THE PREFERRED EMBODIMENTS

The present embodiments comprises an apparatus and method for running an operation such as a test on a plurality of applications distributed on networked stations, and further relates to use of such apparatus and method for testing of integrated functionality of such a plurality of applications.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of better understanding the present invention, reference is first made to the construction and operation of conventional (i.e., prior art) systems as illustrated in FIGS. 1-4.

FIG. 1A is a simplified schematic diagram showing a standard interaction pattern of a user 20 interacting with a computerized application 22. User 20 creates a series of inputs 24 which he communicates to application 22. Application 22 creates a series of outputs 26 which it communicates, typically by means of a display screen or printed output, to user 20.

FIG. 1B is a simplified schematic diagram which shows an interaction pattern typical of situations in which the role of user 20 is taken over by an automated operator 31, which operates an operand system 33, shown here as an application 22. In FIG. 11B inputs 24 arrive at application 22 as they do in FIG. 1A, and outputs 26 are generated by application 22 as they are in FIG. 1A, but the role fulfilled by a human user 20 in FIG. 1A is fulfilled by automated operator 31 in FIG. 1B. An example of such an arrangement is a software testing tool 30 such as a single point script based tool of the kind described in the background, functioning as automated operator 31 and used to test the functionality of application 22. Testing tool 30 creates inputs 24 and sends them to application 22. Application 22 creates outputs 26, which are received by testing tool 30. Testing tool 30 may then compare received outputs 26 to a set of expected outputs 28 for purposes of creating a report 32 documenting differences between expected outputs 28 and actual outputs 26.

Reference is now made to FIG. 2, which is a simplified diagram schematically representing a plurality of human users 20 interacting with a multi-user multi-station system 40 comprising a set of applications 22, some of which are I/O applications 44 having input/output capabilities for communicating with users 20, and some of which may be other applications capable of communicating with each other and with I/O applications 44, but not communicating directly with users 20. In typical operation, each user 20 supplies input 24 to system 40 through one of I/O applications 44, and each user 20 also receives output 26 typically from the I/O application 44 to which he supplies input 24.

Reference is now made to FIG. 3, which is a schematic representation of several configurations similar in purpose to the configuration of FIG. 1B, namely showing an automated operator 31 being used to operate an operand system 33. In FIG. 3 operand system 33 is shown as a multi-user multi-station system 40 similar to that shown in FIG. 2. In the case of FIG. 3, however, I/O applications 44 communicate not with human users 20, but rather with I/O operators 50 which provide input/output capabilities to automated operator 31.

Three structural alternatives are presented in FIG. 3. In FIG. 3C, automated operator 31 is implemented as a set of I/O operators 50, each in communication with an I/O application 44, the set of I/O operators 50 communicating with, and being coordinated by, a command module 52.

In FIG. 3B, automated operator 31 is implemented as a single automated operator process 55 combining the functions of I/O operators 50 and command module 52, and communicating with a plurality of I/O applications 44.

In FIG. 3A, automated operator 31 is implemented as a set of I/O operators 50, each in communication with an I/O application 44, yet the set of I/O operators 50 is not coordinated by a command module 52. In this structure, either the activities of I/O operators 50 are uncoordinated, or their activities are coordinated by a pre-programmed sequence of activity commands 54 such as a script 56, enabling coordinated activities among I/O operators 50, and consequently among I/O applications 44, yet without necessitating real-time communication among I/O operators 50.

Other similar configurations, not shown, are also known in the art, such as a configuration similar to FIG. 3A but in which I/O operators 50 are networked processes communicating with each other through a communications network.

The various configurations presented in FIG. 3 are used, for example, by software testing tools such as were discussed in the context of the discussion of FIG. 1B. Automated operator 31 may be a software testing tool 30 such as single point script based tester or multi-point script-based load tester or similar program. In the example of tools marketed by Mercury Interactive such as were described hereinabove, FIG. 3C provides a typical implementation, where I/O operators 50 are implemented by single point script based tester or like scripts, and the role of command module 52 is fulfilled by multi-point script-based load tester.

Reference is now made to FIG. 4, which schematically presents interaction patterns typical of a configuration such as that presented in FIG. 3C, with automated operator 31 implemented as a software testing program 30 such as single point script based tester/multi-point script-based load tester, according to methods in the prior art. FIG. 4A shows a typical interaction pattern, not dissimilar to the interaction pattern shown in FIG. 2 where multi-user multi-station system 40 is operated by a plurality of human users 20.

Thus in FIG. 4 each I/O application 44 interacts with an I/O operator 50 as if that I/O application 44 were an independent process, interacting with a particular I/O operator 50 on a one-to-one basis. In this prior art configuration, interaction between automatic operator 31 and multi-user multi-station system 40 is largely confined to interactions between individual I/O operators 50 and particular I/O applications 44 with which they individually interact. There is almost no form of interaction which takes into account dependencies between one I/O application 44 and another, or between one I/O operator 50 and another. The unique exception to this rule, the unique dependency of one I/O application 44 upon another I/O application 44, or of one I/O operator 50 upon another I/O operator 50, is presented in FIGS. 4B and 4C.

FIGS. 4B and 4C show an interaction pattern created by the use of the “rendezvous point” technology provided by the multi-point script-based load tester of the kind mentioned above.

Under “rendezvous point” technology, a plurality of I/O operators 50 may be instructed to wait until some particular output 26 is received from all I/O applications 44 of a defined set of I/O applications 44, before proceeding with further activity. The first phase of such an operation is seen in FIG. 4B, where each of a selected set of I/O applications 44 must provide an output 26 which is an expected specific output 27. That is, each of expected specific outputs 27 here labeled 71, 72 and 74 must be received by an appropriate I/O operator 50, before the second phase of operation can commence. FIG. 4C presents a second phase of such an operation, where I/O operators 50 are enabled to resume communicating inputs 24, each to its respective I/O application 44.

Reference is now made to FIG. 5, which is a simplified net diagram illustrating an interaction pattern among a plurality of networked units according to a first preferred embodiment of the present invention. A supervisor apparatus 80 includes at least one operating unit 82. Supervisor apparatus 80 further includes at least one evaluator 85. An evaluator 85 is preferably associated with or, more preferably, integrated with, each operating unit 82. Operating units 82 are for sending inputs 24 to a plurality of I/O applications 44 which together constitute a multi-station multi-application networked system 40. Operating units 82, in conjunction with associated or integrated evaluators 85, also receive outputs from that plurality of I/O applications 44, which typically are distributed on a plurality of networked stations. Thus operating units 82 with their associated evaluators 85 bear similarity to I/O operators 50 described hereinabove in the context of a discussion of prior art, in that both I/O operators 50 and operating units 82 send inputs 24 to a plurality of I/O applications 44 which together constitute a multi-station multi-application networked system 40, and both I/O operators 50 and operating units 82 (with their associated evaluators 85) receive outputs 26 therefrom. In sharp distinction, however, to the methods of prior art, each operating unit 82 and associated evaluator 85 is not limited to communicating only with a particular I/O application 44. In one preferred construction, each operating unit 82 may send input to a plurality of I/O applications 44 and, with evaluator 85, may also monitor outputs 26 from a plurality of I/O applications 44. It is noted that operating unit 82 and I/O application 44 may be implemented on a same physical station, or on distinct stations.

In an alternate preferred construction, each operating unit 82 communicates with a single particular I/O application 44, (e.g., 82a communicates with 44a, 82b communicates with 44b, 82c communicates with 44c), but each operating unit 82 also communicates with one or more other operating units 82, typically running on different stations, each of which units 82 similarly communicates with a particular I/O application 44 and with other operating units 82. Under this construction, each operating unit 82 can send to other operating units 82 information about processes occurring within the I/O application 44 with which it communicates. Under this construction each operating unit 82 and its evaluator 85 can further receive from other operating units 82, running on other networked stations, information about processes occurring within the I/O applications 44 with which they communicate.

Thus, in both of the aforementioned constructions, as well as in constructions combining elements of both aforementioned constructions and in similar constructions, each operating unit 82 is able to monitor, and is consequently enabled to respond to, events in processes occurring in a plurality of applications 44, either by communicating directly with that plurality of applications 44, or else by communicating with a plurality of operating units 82 which in turn communicate with that plurality of applications 44. Thus, in contrast to I/O operators 50 mentioned above in the context of a description of techniques of prior art wherein each I/O operator 50 is largely limited to communicating with and responding to only a single application 44, operating units 82 of the present invention can monitor and respond to processes occurring in the integrated activities of multi-station multi-application system 40 as a whole, since they are enabled to be aware of events occurring in a plurality of processes in a plurality of applications 44 running on a plurality of stations.

A synchronizer 84 associated with supervisory unit 80 is provided for synchronizing activities of operating units 82, which are thereby enabled to respond in an organized manner to the integrated activities of multi-station multi-application system 40. Synchronizer 84 may be implemented as a computer program running as an independent supervisory process communicating with operating units 82, or alternatively synchronizer 84 may be implemented as a set of rules, such as for example an enhanced script 86 that controls activities of an operating unit 82, or, as a further example, as a set of enhanced scripts 86 coordinated with one another, each controlling activities of an individual operating unit 82. Synchronizer 84 typically comprises rules for controlling the activities of operating units 82 according to evaluations of evaluator 85, those evaluations being of outputs received from applications 44 and of signals received from other operating units 82. Based on its evaluations, evaluator 85 selects commands for sending by operating unit 82 to application 44. As described in detail hereinbelow, synchronizer 84 enables to synchronize activities of a plurality of operating units 82, and thereby enables to synchronize, coordinate, and control activities of a plurality of applications 44, thereby running an integrated operation on a plurality of applications 44 distributed on networked stations.

As is explained in detail hereinbelow, an optional coordinator 91 may be utilized to provided additional coordination and control functionality for a plurality of operating units 82. Coordinator 91 may, for example, initiate activities of operating units 82, distribute to operating units 82 sets of rules, such as sets of scripts 86, for directing the activities of operating units 82, and may collect, record, summarize, evaluate, and report on data contained in output from applications 44, in messages from operating units 82, or indeed in information from any other source within the distributed stations of the network.

Coordinator 91 may be an independent unit as shown in FIG. 5, or alternatively, the functionality of coordinator 91 may be integrated into one or more operating units 82.

Coordinator 91 may typically participate in the synchronization activities of synchronizer 84. In particular, coordinator 91 may distribute scripts 86 to operating units 82, and coordinator 91 may itself be controlled by a script 86.

It is useful, for understanding the present embodiments, to compare interaction patterns enabled by prior art, presented by FIG. 4, to interaction patterns enabled under an embodiment according to the present invention and presented in exemplary form in FIG. 5.

Thus, in a simplified example of an interaction pattern according to an embodiment of the present invention presented in FIG. 5, operating unit 82a, under instructions from synchronizer 84 which may be an independent process or may alternatively be embodied in a set of rules such as an enhanced script 86, communicates an input 92 to application 44a. As a result of receiving input 92, application 44a creates an output 94, which is detected by operating unit 82c. In a preferred embodiment, output 94 is detected by operating unit 82c directly. In the alternative preferred embodiment described above, wherein each operating unit 82 communicates with only one application 44, output 94 is detected by operating unit 82a communicating with application 44a, whereupon operating unit 82a sends a message to operating unit 82c informing it of the existence of output 94, and optionally further providing to operating unit 82c additional information about output 94, such as the content of output 94, or an evaluation of that content.

Having detected output 94, operating unit 82c, under instruction from an enhanced script 86, responds by sending input 96 to application 44c and input 98 to application 44b. As discussed above, output 98 is in one construction sent directly from operating unit 82c to application 44b, while in an alternative construction a message from operating unit 82c to operating unit 82b causes operating unit 82b to send output 94 to application 44b.

Application 44c then sends a new output 102, which is detected by operating unit 82a, either directly or, under an alternate construction, through the participation of operating unit 82c.

The interaction pattern here described is, of course, merely a particular example of a possible interaction in an embodiment according to the present invention. The interaction is characterized by the fact that an event in a first I/O application 44 of a multi-user multi-station system 40 can serve, under control of supervisor apparatus 80, to trigger input to, and consequently further processing by, a second I/O application 44 of multi-user multi-station system 40.

Referring again to FIG. 5, details of a further preferred embodiment according to the present invention are now described. The further preferred embodiment is designed as an extension of the language and system of the single point script based tester/multi-point script-based load tester applications described hereinabove. The further preferred embodiment is a testing tool 30, for performing functional tests and/or regressive tests on an integrated operation 40 running as a plurality of applications distributed on networked stations.

According to the further preferred embodiment, each operating unit 82 of supervisory apparatus 80 acts according to a set of rules in the form of an enhanced script 86 having commands expressed in a language consisting of the script language used by single point script based tester and multi-point script-based load tester, augmented by a set of language extensions. These language extensions are for extending the capabilities of single point script based tester/multi-point script-based load tester scripts so as to enable a system under control of enhanced scripts utilizing the language extensions to run an integrated operation on a plurality of applications distributed on networked stations, and in particular, in a preferred embodiment, to test such an integrated operation by performing functional tests and/or regressive tests thereupon. The further preferred embodiment might, for example, be used to test a set of applications distributed on networked stations and together constituting a multi-user multi-station software system. Alternatively, a set of distributed applications run under this embodiment may themselves be test applications operative to test locally installed test subject applications, and themselves include functional testing ability and/or regressive testing ability.

Thus, in a preferred embodiment of the present invention supervisor apparatus 80 under control of a set of commands expressed in enhanced scripts 86 utilizing a command language similar to the language of single point script based tester/multi-point script-based load tester scripts but including a set of language extensions specified hereinbelow, can run an integrated operation on a plurality of applications 22 distributed on networked stations. In this embodiment, an operating unit 82 or a plurality of operating units 82 is designed and constructed to send sets of commands in a sequence, each command being to a predetermined I/O application 44 running on a selected station. Operating units 82 and associated evaluators 85 are further designed and constructed to evaluate outputs received from each I/O application 44. Evaluator 85, associated with an operating unit 82 or a with a plurality of operating units 82 is designed and constructed for selecting a next command to send, selection being made in accordance with evaluation of outputs received from one or more I/O applications 44 and in accordance with rules presented by synchronizer 84. Thus, supervisor apparatus 80 serves to determine a sequence of commands to be sent to an application 44, which determination may be made in accordance with output from a plurality of I/O applications 44 running on a plurality of stations. Supervisor apparatus 80 may further include a debugger 81 for debugging processes occurring within one or more I/O applications 44 and/or within one or more operating units 82 or in coordinator 91.

For providing the enhancement over prior art herein described, several small but important extensions to the script language of the single point script based tester/multi-point script-based load tester applications are required. The required extensions refer to what is called herein a “synchronization point”, which concept is explained with reference to FIG. 6.

Reference is now made to FIG. 6, which is a simplified network diagram illustrating functional relationships between networked components in accordance with a preferred embodiment of the present invention. A synchronization point 83 is introduced into integrated operation 40 to temporally affect operation of one or more I/O applications 44. In an example of a preferred embodiment presented in FIG. 6, synchronization point 83 embodied in a script 86a controlling operating unit 82a causes delay of a data message. Such a data message in general comprises a predetermined set of commands, intended to be sent from one of the operating units 82 and to be received as input by an I/O application 44. Delay of the sending of the data message preferably ends when supervisor apparatus 80 detects an output from one of I/O applications 44, which output corresponds to some predefined identity or characteristic.

In the example shown in FIG. 6, a first synchronization point 83 causes a command for bringing about the sending of a particular input 110 from operating unit 82a to I/O application 44b to be temporally dependent on prior receipt by operating unit 82a of a particular output 112 from application 44a. According to synchronization point 83, when required output 112 is received by operating unit 82a, input 110 is released, and is sent from operating unit 82a to I/O application 44b.

According to an alternative construction described above, input 110 is sent to application 44b by operating unit 82b, which receives notification from operating unit 82a causing it to send input 110 to application 44b. More specifically, a second synchronization point 87 in a script 86b controlling operating unit 82b causes operating unit 82b to wait until receiving a required message 89 from operating unit 82a before releasing input 110 to application 44b.

Under further alternative methods of construction, message 89 may be transferred from operating unit 82a to operating unit 82b either directly, by data path 114, or alternatively through the mediation of coordinator 91, as shown by data path 116.

Table 1 presents a formal definition of a set of synchronization point commands extending the single point script based tester/multi-point script-based load tester script language, for implementing the functionality of a synchronization point according to a preferred embodiment of the present invention.

TABLE 1
SYNCHRONIZATION COMMANDS

Command Name: Wait_for_sync_point
Description: Causes process to wait at the synchronization point until

the station is released by another station, or timeout is expired. If timeout
has not expired, then it retrieves a string that is transferred by the releaser
station.

Parameters:
In: Synchronization point name (free string).
In: Maximum waiting timeout in seconds.
Out: String values that transfer by the releaser station.
Return: 1 when timeout is expired, otherwise return 0
Command Name: Release_sync_point
Description: Releases stations that are waiting for a particular

synchronization point, or releases stations when they reach that
synchronization point. Also enables transfer of data to the released
stations.

Parameters:
In: List of station names.
In: Synchronization point name.
In: String value as data to be transferred to the release stations.
Return: 0 when success, otherwise 1
Remarks:

1. The station names in the list are separated by the sign “;”
2. The station's name is the NT network computer name

Command Name: Check_sync_point
Description: Checks if synchronization point is released in the current

station. If it is released it returns 0 and retrieves the string that transfers
it from the releaser station.

Parameters:
In: Synchronization point name.
Out: String values that are transferred by the releaser station.
Return: 0 when the Synchronization point is released in the station,

otherwise return 1

Command Name: Delete_sync_point
Description: Delete synchronization point. After performing this

command, other commands behave like before the synchronization
point was released.

Parameters:
In: Synchronization point name.
Return: 0 always.

In an enhanced script 86 controlling an operating unit 82 which supplies inputs 24 to an I/O application 44, the presence of a Wait_for_sync_point command causes a freezing of a process managed by that operating unit 82 until receipt of a Release_sync_point message having the same synchronization point name. In the language extension of the present embodiment, in contrast to the “rendezvous point” commands of the prior art, the freezing is a unidirectional operation; in that it creates a unidirectional temporal dependency. That is, neither the presence of a Wait_for_sync_point command in an enhanced script 86 controlling a first operating unit 82a, nor execution of that Wait_for_sync point command by a first operating unit 82a, thereby causing a “wait” state in the operations of operating unit 82a, implies anything at all concerning delays or lack of delays in operations of second operating unit 82b. Neither does the presence or execution of a Release_sync_point message in a script commanding a second operating unit 82b, which execution thereby releases a wait state in operating unit 82a and allows it to continue processing, imply anything at all concerning delays or lack of delays in operations of second operating unit 82b.

Inspection of the command syntax of the set of synchronization point commands presented in Table 1 reveals further features of synchronization point commands. A message generated by a Release_sync_point command according to a presently preferred embodiment may be sent to all operating units 82, or else to a selected set of operating units 82 specified in an appropriate parameter of the Release_sync_point command generating the message. Further, the effect of the issuance of a Release_sync_point message depends on the context in which the corresponding Wait_for_sync_point command appears. Thus, a particular Release_sync_point message may provoke quite different responses in a plurality of different contexts, whether in a same application or in a plurality of different applications.

A Release_sync_point command may further supply additional message content, in addition to the fact that a “release” has been issued. The ability to supply additional message content can be used to implement procedures whereby an output 26 received by an operating unit 82 is evaluated, and information generated by that evaluation is communicated to other processes. In such a case, one such message, or a plurality of such messages, may then serve as a basis for command path decisions. Further, a Release sync point command, used together with a Check_sync_point command also referred to in the above table, may be used to distribute any kind of information among processes. In particular, information so transmitted may include information generated by supervisor apparatus 80, which may be unrelated to a received output of an I/O application 44. The information may further include messages unrelated to timing delays of any kind. A Release_sync_point command, used together with a Check_sync_point command, might be used for example to transmit the information that a certain data message has been sent for transmission from one process to another, or to transmit the information that such a transmitted message has, or has not, been successfully received.

A Wait_for_sync_point command may include a timing delay setting a maximum waiting time, such as might be used to prevent an infinite delay caused by waiting for an event which, because of a design error, a programming error, or an operation error, never occurs. Since the specified timing delay is specific to a particular instance of execution of a Wait_for_sync point command, each process waiting for a particular Release_sync_point message is enabled to react individually and independently, both to arrival of an awaited message and to non-arrival of an awaited message.

A Check_sync_point command is provided to allow a script to provide an alternative command pathway for execution of operations, depending on the status of a specified synchronization point, while yet not necessarily freezing operation of an application if that synchronization point has not yet been released.

Thus, features of the language extension herein described enable a broad variety of programmed interactions among networked I/O applications 44, operating units 82 and synchronizer 84 of supervisor apparatus 80.

Reference is now made to FIG. 7, which is a simplified block diagram showing a supervisor apparatus for running an integrated operation on a plurality of applications distributed on networked stations according to an embodiment of the present invention. Supervisor unit 120 comprises an operating unit 122 for sending selected commands to at least one preselected station. For each command all of the stations may be selected as target stations or only a subset, including a subset of just one. It is noted that the term “command” is here used in the very general sense of “input influencing behavior”. In the case of an embodiment that is a software testing tool, for example, a “command” may be a unit of simulated data input from a simulated user.

The supervisor is also able to evaluate outputs received from the network. Individual outputs may indicate the status of one or more stations or some feature concerning the integration of operation of the stations. The evaluation functionality may be incorporated integrally within the operating unit 122 or may be provided as an evaluator 124 within the overall operating functionality.

The supervisor 120 preferably also comprises a synchronizer 126, associated with the operating unit, for providing a basis for selecting a next command to send, in accordance with the results of the evaluation. There is thus formed a sequence 128 of commands, which sequence is at least partly determined by output received from the network by the supervisory unit.

In a particularly preferred embodiment, the integrated operation is a test operation and the sequence of commands is generated according to a test script telling the application units what to do at various stages of the test. Output from the network indicates how the test has gone so far and allows integrated behavior of the applications to be followed.

The integrated test may comprise functional and/or regressive tests to be carried out on the applications.

The distributed applications which are the subject of the supervision of the supervisory unit may be test applications operative to test locally installed test subject applications.

Preferably, the synchronizer comprises a synchronization point definer 130, which defines synchronization points 73 within the integrated operation. Preferably, the synchronization points are usable at each station to temporally affect operation at said station, as discussed above.

Preferably, definer 130 is operable to include along with the synchronization point definition a list of one or more stations which are intended to use the synchronization point and/or a list of one or more stations to respond thereto in a first way and/or a list of at least one station to respond thereto in a second way. In other words, the same synchronization point can include definitions that bring about different responses in different stations.

The synchronization point definition may include one, two or more events from the evaluation. In other words the definitions that are included with the synchronization points may include any desired combination of output events received by the supervisor from the network, and may thus include output combinations indicative of different types of integrated behavior.

Likewise the synchronization point definition may list one or more stations to react to a first event and one or more stations to react to another, different event. Again this is a feature that can be useful in testing integrated behavior of a system.

The definer may be capable of dynamically changing the definitions associated with the synchronization points, and different stations may be set to respond in different ways to the same event or to different parts of an event.

Examples of doubled events include an indication of successful sending of data from a first station and an indication of successful receipt of the data at a second station. Additional examples of doubled events include an indication of successful sending of data from a first station and a lack of indication of successful receipt of the data at a second station.

The definer may be able to set time limits such as a maximum time delay for waiting for a synchronization event associated with said synchronization point. Typically it is also be possible to define different maximum time delays for different stations.

In the case of testing, the outputs may well be the results of test scripts run by, or to control, each test application, and the synchronizer may freeze running of said scripts at one or more of the applications until receipt of a predetermined output from a predetermined other of said applications. Alternatively, freezing of the operation may occur until receipt of an indication that a predetermined other applications is ready to carry out a given operation.

Typically the supervisor can inform one of said stations about occurrence of an event at another of said stations.

The information supplied may include supervisor-generated data regarding the occurrence, or station generated data regarding said occurrence.

In a preferred embodiment a coordinator 91 is provided to coordinate activities of a plurality of operating units 122. Coordinator 91 may send synchronizer information, such a scripts, to operating units 122, and may collect and report on information concerning the activities of the system. Thus, in a preferred embodiment, coordinator 91 sends a series of scripts to a plurality of operating units 122, thereby initiating and controlling a series of integrated operations executed in sequence. Coordinator 91 preferably comprises a logger 268 for recording information about events occurring in the activities of operating units 122 or in the activities of applications 44. Coordinator 91 also preferably comprises a report generator 270 for generating reports based on this recorded information. Report generator 270 preferably comprises a summarizer 93 for summarizing the logged information. Report generator 270 preferably also comprises a describer 95 for evaluating and characterizing the logged information.

Reference is now made to FIG. 8, which is a simplified block diagram showing test apparatus according to an embodiment of the present invention. Test apparatus 140 is a function of supervisor apparatus 120 preferably run on a station to test an application 142 thereon by running an individual script 86. Script 86 may be sent to test apparatus 140 from a coordinator 91. The test is preferably integrated with tests on remote stations networked with the station running test apparatus 140.

The apparatus preferably includes an operation unit 144 for running a test on the application according to script 86.

The script preferably includes synchronization points 73 which allow input from the network to be used to synchronize the running of the script with tests being carried out at other stations.

The apparatus preferably includes an evaluator 146, associated with the operation unit 144, for evaluating outputs from the tested application and for applying definitions associated with the synchronization points, in combination with input from the network, in order to achieve synchronization. Synchronization points may be pre-formulated as part of a script, or may be incorporated into a script by supervisor unit 120 or by coordinator 91. Definitions associated with synchronization points may include not only signals received from the network, but also signals generated locally, to control flow of said predetermined commands.

An optional debugger 148 is provided for enabling an operator to monitor the testing process and intervene manually therein, as an aid to developing test scripts.

Reference is now made to FIG. 9, which is a simplified flow chart describing the running of a script at an individual station, according to a preferred embodiment of the present invention.

The script is received from coordinator 91 or installed directly in operating unit 144. A command is selected according to the script. The selected command is sent to the application and output is received from the application. The received output may be evaluated and notification may be sent to the network for further evaluation by coordinator 91 and for allowing synchronization at other stations. At the same time input may be received from the network. Received input is evaluated for synchronization at the current station. On the basis of input from the network and from the local application, and in accordance with rules embodied in the script, a new command is selected for sending to the application. Successive commands are thus selected and sent to the application, according to the requirements of the script, until the end of the script is reached.

It is noted that evaluation of received output from the application may comprise the step of comparing the output to an example of expected output, which may be provided to evaluator 85 in conjunction with, or as an integral part of, script 86. Thus, under this optional method, script 86 provides for sending input to an application, and further provides for comparing output from the application to an example of expected output. Notifications provided by operating unit 144 to the rest of the system may include notification of evaluations by evaluator 91 based on this comparison of expected output from the application to actual output therefrom.

Reference is now made to FIG. 10, which is a simplified flow chart showing a supervisor method for running an integrated operation on a plurality of applications distributed on networked stations, according to a preferred embodiment of the present invention, from the point of view of coordinator 91. The method comprises a series of stages beginning with the option of scheduling a series of tests. Testing per se begins with selecting a test. The device has one or more tests each of which is a different combination of scripts. For example the device may have a series of scripts 1 to 10 for carrying out on a network having three stations. Test number 1 may use script no. 1 on each station. Test no. 2 may use scripts 2, 3 and 4 on each station, test no. 3 may use script 5 on stations 1 and 2 and script 3 followed by script 4 on station 3, and so on.

The scripts are distributed to the respective stations and the test is begun. Results are then received from the network, and may be logged, summarized, evaluated, and reported. Coordinator 91 may optionally provide for scheduling series of tests, and for causing the running of a test to be dependent on an evaluation of output from a previous test.

Reference is now made to FIG. 11 which is a simplified flow chart describing a preferred method for running a multi-station test on a plurality of stations, according to a preferred embodiment of the present invention.

As shown in step 200 of FIG. 11, a tester will first describe a test procedure, producing a document describing the purpose of the test, listing all the steps to be performed in executing the test, and describing for each step the inputs for that step and the expected results of executing the step. In addition, a precondition may be listed for the executing of any particular step. For example, a precondition for a particular step might be that a particular data field in a data input screen of the application must be filled, by a user, with a particular data value, before the particular step in question is performed. It may be noted that in contrast to prior art, the precondition for executing a step on a given station may be an event occurring on a different station.

At step 202, a tester builds a test script, either by creating a new script or by modifying an existing script. The script built at step 202 includes a list of test inputs, together with the outputs expected to be produced by the tested system, when the tested system is provided with the given inputs. The tester should carefully synchronize the script with the application according the specific preconditions listed at step 200. He might, for example, include in the script a command for waiting until a data input field in the application is filled with a particular value. Note that in contrast to prior art, the synchronization capabilities available according to an embodiment of the present invention enable to synchronize between the application and the scripts in all the stations that are involved in the test. The synchronization enables to freeze a script running on a first station at a particular point until a specified event occurs in a second station.

At step 204 the tester runs (executes) the test script. Running a script inserts inputs into the tested system, according to the inputs defined in the script. Whereas a script could be executed by a human operator, running a script is more typically accomplished using a running mechanism such as operating unit 144 shown in FIG. 8, for operating the tested system automatically. The running script mechanism may use synchronization commands to freeze the script at any given point, so as to wait until the tested application is ready for further operations.

As a result of the running of the test script, inputs supplied to the tested system according to the script cause the tested system to produce an actual running output result. The produced output is then automatically compared to the expected system output. Note that during the running of the script the synchronization commands presented in Table 1 allow freezing the running script in one station till the tested application is ready in another station. The synchronization commands further enable notification to a first station or to a first plurality of stations about an event occurring in a second station. The synchronization commands also support the transmission of further information about such an occurring event, or indeed any other essential information, to the target stations. Such information can be used for many purposes. For example, it may be used by a decision-taking algorithm in a script, to decide which tests need subsequently to be run, and which functions need to be tested. Similarly, information contained in the notification can include information about the station sending the notification, and it can further contain the results of a test in yet another remote station.

Referring again to FIG. 11, at step 206 the system creates a report of differences between expected output and actual output. This report points out possible problems in the tested system. In a preferred embodiment, the produced report is a centralized report incorporating information about problems in the tested system from all the stations that are involved in the test.

At step 208 the tester checks and analyzes the report produced by the system in step 206.

At optional step 210, the tester may schedule the running of series of tests. The automatic running of scheduled series of tests is common, for a variety of practical reasons. For instance, hardware resources for testing may be available only at night. In some cases the running of tests may take a long time and the tester may want to use the testing station for developing tests during working hours. Multi-station tests can substantially load a network. For these and similar reasons, it is often convenient to schedule series of tests to be run unattended, one after another, at times convenient to the tester. In a preferred embodiment the testing scheduler enables setting rules for proceeding from one test to another in a series, such as, for example, requiring the successful completion of a first test before a second test is run.

It is noted that in contrast to prior art, a test scheduling system according to the present invention enables requiring the completion of the running of all of a set of test scripts at all the tested stations before the test is deemed complete and a following test may be begun. Alternatively, a test scheduling system according to the present embodiments also enables requiring the completion of the running of a selected subset of test scripts at a selected subset of tested stations before the test is deemed complete and a following test may be begun. Additionally, the rules for proceed from one test to another may take into account the multi-station aspect of the test. Thus, a rule may be provided whereby if a problem is found in one or more stations, the subsequent test will not be run on any station, or a rule may be provided whereby if a particular test fails on a particular station, a selected series of additional tests will be run on a selected subset of stations.

Reference is now made to FIG. 12, which shows a more detailed embodiment of the present invention implemented as a tool for executing multi-station tests. A multi-stations test tool (“MST”) 220 comprises a plurality of station testing tools 218 designed for functional and regression testing of individual stations. Station testing tools 218 comprise a test script language (“TSL”) 222 according to the teachings of prior art, and further comprise MST extension commands 230, and an MST agent 240. Multi-stations test tool 220 further comprises an MST controller application 250.

MST extension commands 230 include two groups. A first group is a set of synchronization commands 232 such as the synchronization commands presented hereinabove in Table 1. A second group is a set of controller interface commands 234.

Synchronization commands 232 facilitate synchronization between scripts in different stations. Synchronization commands 232 also enable to safely transfer data between scripts running in different stations, while ensuring that the receiver station waits until the data arrives. Synchronization commands 232 coordinate between stations without necessarily running involving coordinator 91, here identified as controller application 250, which is a significant advantage for debugging the scripts, since a particular script running on a particular station can be tested and debugged without necessarily involving the running of other scripts on other stations. In this context it may be noted that in a preferred embodiment controller application 250 is able to supply data messages to station-testing tool 218 (e.g., to a operating unit 82 of FIG. 6) which are interpreted as if coming from an application 44. This ability provides a further advantage in the process of developing, testing, and debugging scripts.

In a simplified example of scripts using several synchronization commands 232, consider a situation in which Stations B and C should perform a particular set of checks after station A is ready. The script for station A includes the command

Rc=Release_sync_point(“B;C”, “Station-A-is-ready”, “ ”), a script for a station B includes the command sequence

Rc=Wait_for_sync_point(“Station-A-is-ready”, data,60)

DoChecksInBAfterStationAIsReady ( ), and a script for a station C includes the command sequence

DoChecksInCBeforeStationAIsReady ( )

Rc=Wait_for_sync_point(“Station-A-is-ready”, data,60)

DoChecksInCAfterStationAIsReady ( )

When station A is ready it executes the Release_sync_point command, releasing stations B and C. Station B, having executed the Wait_for_sync_point command, waits for notification “Station-A-is-ready” before proceeding with its operation. Once released by station A, station B, according to its script, will stop waiting and will perform the command DoChecksInBAfterStationAIsReady ( ).

Station C performs the command DoChecksInCBeforeStationAIsReady( ) while station A is getting ready. When the script in station C reaches the command Wait_for sync_point, the “Station-A-is-ready” event may already have been released by station A. In this case station C, according to its script, needs not wait but continues immediately to its next command DoChecksInCAfterStationAIsReady( ).

Referring again to FIG. 12, Table 2 presents a set of controller interface commands 234. Controller interface commands 234 enable receiving and sending information to and from the MST Controller.

TABLE 2
CONTROLLER INTERFACE COMMANDS

Command Name: Get_script_parameters
Description: The tester can define parameters in the MST Controller

for each station. During the running of a test that runs via the
controller, the script parameters can be retrieved by using this command.

Parameters:
Out: Swing value for getting the script parameters.
Return: 0 always.
Command Name: Test_running_status
Description: The script can notify the controller about the completion

of running a script and notify the controller about the running status.
The status can be one of the following:

SUCCESS when the test is finished without finding mistakes.
FAIL when mistakes are found, but the scheduler can run the next

test according to the “Proceeding Method” field.

STOPPED when finding mistakes and the next test cannot be run.
Parameters:
In: One of valid statuses.
Return: 1 when invalid status is supplied, otherwise return 0.
Command Name: Report_to_controller
Description: This command inserts a message to the central report in

the MST Controller.

Parameters:
The customer can configure this command by setting the command

parameters according to his requirements.

Command Name: Get_my_station
Description: This command returns the current station identification.
Parameters:
Out: Station Id.
Return: 0 always.

Reference is now made to FIG. 13, which shows additional detailed elements of MST agent 240. In a preferred embodiment, MST agent 240 runs on each tested remote station. MST agent 240 handles the transferring of data among station testing tools 218 running on individual stations, and also handles transferring data between station testing tools 218 and MST Controller 250. MST agent 240 comprises a communication agent 242 responsible for the transferring of all data between stations, and a display agent 244 which provides to a tester the ability to view information about the synchronization points in station testing tools 218 and the ability to view information about the progress of commands sent to and received from MST controller 250. MST agent 240 further optionally comprises an interface agent 246, capable of interacting with communication agent 242 and with display agent 244, for interfacing between MST agent 240, station testing tools 218 running on remote stations, and MST controller 250.

Reference is now made to FIG. 14, which shows additional details of MST controller 250, an embodiment of coordinator 91 described hereinabove. MST controller 250 includes a MST controller protocol 260, a MST run configuration definition 262 comprising a MST definition 264 and a group test definition 266, a status display 274, a central log 268, a central report generator 270, and a MST scheduler 272.

Communication between station testing tools 218 and MST Controller 250 is organized according to MST Controller Protocol 260 presented in detail hereinbelow.

MST controller 250, which is an embodiment of coordinator 91 described hereinabove, supplies a full running environment for tests that run on multiple stations. The main tasks of MST Controller 250 are handling MST run configuration definition 262, running MST controls, supporting the viewing of synchronization points, gathering tests results, building a centralized report for test analysis, and MST scheduling.

With respect to MST run configuration definition 262, MST controller 250 provides facilities for creating, storing, and using MST definition 264 describing a multiple-station test running environment, and group test definition 266 comprising groups of MST definitions defining multiple MST tests to be run one after another.

According to a preferred embodiment of the present invention, MST definition 264 is an ASCII file with an “MST” extension. According to this preferred embodiment, the definition file's name is the test's name, and the file includes the following data:

A list of stations involved in the test, where each station name is that station's computer name in an NT network;

A script name (full path) defined for each station;

A script parameter string (free string) for each script;

Remarks about the test; and

Data useful for scheduling this test among a plurality of tests to be run on the system.

With respect to group test definition 266, according to a preferred embodiment there is provided a definition of groups of multi-station tests defined in a file with GMS extension. This file contains a list of groups, where a group is a free text field, and a list of MST definition full-path file names for each group.

MST controller 250 runs a multi-station test according to MST definition 264. MST controller 250 interacts with (or runs) an individual station testing script in each tested station that is defined in MST definition 264. The capability of MST controller 250 to interact with or run individual station testing scripts enables the temporary modification (at run time) of the station list of MST definition 264. These modifications enable the addition or deletion of stations from the MST list, and enable the change of the script name or script parameters of station in the stations list, at run time.

A running status display 274 is shown in the controller for each tested station. Running status display 274 is updated according to a variety of events, such as those shown in Table 3.

TABLE 3
STATUS REPORTS BASED ON SYSTEM EVENTS

| Running Status | Updated Events |
|---|---|
| Not Running | When MST file is opened |
| | When a new station is added to MST |
| Loading | When a MST starts running |
| Running | When station test tool is not running and |
| | Display Agent succeeds in creating a testing |
| | process. |
| | When station test tool is running and interface |
| | agent gets Load Script command. |
| Load Script Failed | When station test is not running and Display |
| | Agent cannot create a testing process. (As |
| | would result if the station test tool were not |
| | installed, for example) |
| | When the station test script cannot be found in |
| | the supplied path. |
| Run Suspended | When the tester selects a station and pushes on |
| | the “Suspend” button. |
| Testing | When the tester selects a station and pushes on |
| | the “Test” button. This event sends Test |
| | command to the Agent to the selected |
| | station. |
| Test Succeeded | When the Agent gets Test command, reacts by |
| | sending “Test Succeeded” status to the |
| | controller. |
| Test Failed | When a test command to a selection station is |
| | not executed and a timeout has expired. |
| Run Succeeded | When the station test script executes TSL |
| | command “test_running_status”, and the |
| | TSL function gets “Run Succeeded” as a |
| | parameter. |
| Run Failed | When the station test script executes TSL |
| | command “test_running_status”, and the |
| | TSL function gets “Run Failed” as a |
| | parameter. |
| Run Stopped | When the station test script executes TSL |
| | command “test_running_status”, and the |
| | TSL function gets “Run Stopped” as a |
| | parameter. |

Central report log 268 is provided to log messages from station testing programs 238 running on individual stations. Report log 268, as a record of the events of the test, constitutes a kind of report. Optionally, central report generator 270 may use information contained in central report log 268 to create an analytic or summarizing report.

The report log structure of a preferred embodiment consists of two parts, one fixed and one user-defined. The fixed part includes a timestamp of each message received by the controller, and the station name of the sender station.

The user-defined part of the log is a user-defined list of fields 278 that are provided in an ASCII file. Optionally, this ASCII file can be edited by a “Controller Report Definition” application 280 provided to facilitate editing the definitions file. The file includes a list of fields (the report columns) and a list of properties for each field. Typical properties include a field name (the column name in the report), field length, and an indication of whether the field is filterable in the controller report.

In a preferred embodiment a maximum of two fields can be filtered in the controller report, these being the first two fields that are defined as filterable fields. In this preferred embodiment, for each field a list of valid values can be defined. Report log 268 is preferably saved in an ASCII file, one line for each message. Each line contains a list of field values separated by the “;” character. Report log 268 can then be ordered by any report column by central report generator 270, though by default new log messages will display on the top of the list.

An additional function of MST controller 250 is the handling of scheduled multi-station tests in a series. MST scheduler 272 enables the running of a list of multi-station tests one by one. The mainly capabilities of the scheduler are:

Building a list of MSTs for running.

Order control capability of the MSTs in the list

Setting start running time of the first MST of a series

Assuring that the next MST will be run only after all the stations in current running MST are finished, and their running status is not “Running”.

A “test_running_status” command is used for updating the controller about changes in the running status of a station. The valid statuses are SUCCESS, FAIL and STOP.

Running the next MST depends on the “Proceed Method” field which can be the following list:

1. ALL SUCCESS—means that the next MST will run only if all the stations finished running with the status Running Status “SUCCESS”.

2. SUCCESS OR FAIL—means that the next MST will run even if there are stations that finished running with Running Status “FAIL”.

Changing “Proceed Method” field value is possible while the MST is running. This change will affect the current running MST immediately, and will affect successive MSTs as well, though it will of course not affect tests already completed.

Displaying statuses of all the MSTs in the list (see Table 3).

The list of MSTs can be loaded from Groups of Multi Stations Test Definition file.

The MSTs list can be modified.

The MSTs list can be organized in structured Groups.

Running of MSTs can be Suspended/Resumed by pressing the “Suspended/Resumed” button. Suspending or Resuming of a group of MSTs affect all the MSTs under the group.

A result directory can be set, wherein the report log of each running MST is saved. The report is in ASCII file format, the filename consisting of the test name with the extension “rep”.

Table 4 lists possible running statuses for the MST scheduler, and the situations which invoke them.

TABLE 4
Scheduler Running Statuses

| Running Status | Updated Events |
|---|---|
| Not | When Groups file is opened |
| Running | When new MST is added into the list |
| Running | When the MST loaded into the Running tab. |
| Run | When the tester selects a station or group and push on |
| Suspended | the “Suspend” button. |
| Run | When the controller received from all the station in the |
| Succeeded | MST status “Run Succeeded”. |
| Run Failed | When the controller received from all the station in the |
| | MST status “Run Succeeded” or status “Run |
| | Failed”, and at least was one with status “Run |
| | Failed”. |
| Run | When the controller received from all the station in the |
| Stopped | MST status “Run Succeeded” or status “Run Failed” |
| | or status “Run Stopped”, and at least was one with |
| | status “Run Stopped”. |
| Done | Only for Groups. When all the MSTs in the group |
| | finish the running. |

Table 5 presents MST Controller Protocol 260, which regulates communication between controller 250 and agents 240 running on the remote stations. Each command structure is <CommandKey><CommandData>

Each Data structure is composed of a list of field values that are separated with “;” sign.

TABLE 5
MST CONTROLLER COMMAND PROTOCOL

Command Key:

CMD_LOG_REPORT

Command Description:

Send Report Log message to Controller.

Command Data Structure (Fields):

Sender station
User message

Remarks:

| 1. | The trigger for sending this command is the |
|---|---|
| | TSL command “report_to_controller” |
| 2. | The controller displays the Report Log messages in |

the Report tab.

Command Key:

CMD_STATUS

Command Description:

Send Test Running status to Controller.

Command Data Structure (Fields):

Sender station
Status

The Status can be one of the following values:

| | |
|---|---|
| STAT_NOT_RUN | “Not Running” |
| STAT_TEST_SUCCESS | “Test Succeeded” |
| STAT_TEST_FAIL | “Test Failed” |
| STAT_RUN_SUCCESS | “Run Succeeded” |
| STAT_RUN_FAIL | “Run Failed” |
| STAT_RUN_STOP | “Run Stopped” |

| | |
|---|---|
| STAT_LOAD_FAIL | “Load Script Failed” |

| | |
|---|---|
| STAT_RUN_SUSPEND | “Run Suspended” |
| STAT_RUNNING | “Running” |
| STAT_LOADING | “Loading” |
| STAT_TESTING | “Testing” |
| STAT_DONE | “Done” |

Remarks:

| | |
|---|---|
| 1. | The trigger for sending this command is the TSL command |

“test_running_status”.

| | |
|---|---|
| 2. | This command can be sent from the Agent to the controller |

as ACK to Test Command.

| | |
|---|---|
| 3. | This command can be sent from the Agent to controller as |

a reaction to the Load Script command.

| | |
|---|---|
| 4. | When the controller gets this command, the controller |

will check the stations running statuses and will decide if
the test is finished. If the checks in all stations are done,
and the MST is running from the scheduler, the controller will
load the next test and run it in all stations.

| | |
|---|---|
| 5. | This command should be sent as the last command in the |

TSL script. As after this command the controller can load the
subsequent running script into the testing unit.

Command Key:

CMD_TEST_STATION

Command Description:

Send Test command from the Controller to Station

Command Data Structure (Fields):

Controller station name

Remarks:

| | |
|---|---|
| 1. | For each tested station in the Running dialog, the tester can |

test the communication by using the “Test” button. This
action will send this command from the controller to the
selected station. The receiver agent in the station will react
with Status command, and the return status will be
STAT_TEST_SUCCESS

Command Key:

CMD_LOAD_SCRIPT

Command Description:

This command is sent from the controller to the agent
for loading station testing script into station testing tool.

Command Data Structure (Fields):

Controller station name
Station testing script (full path)
Script parameters

Remarks:

| | |
|---|---|
| 1. | The Agent updates the controller station's name after this |

command. Prior to this command, the agent takes the
controller station name from the previous Load Script
command for sending messages to the controller. So,
after the installation and after moving the controller to a
different station, sending messages to the controller will fail.

| | |
|---|---|
| 2. | When the Display Agent is running, and station testing tool |

is not loaded, the Display Agent will run the station testing
tool with batch mode and the script in the command line.

| | |
|---|---|
| 3. | When station testing tool is running, the Agent will |

insert the script by operating the station testing tool
“File/Open”, and insert the file name. It will change
it to Debug mode and run the script from the top. The
interface should be changed in the future to a regular
window message.

| | |
|---|---|
| 4. | When Display Agent or station testing tool are not running, |

the script cannot be loaded.

Command Key:

CMD_GET_SCRIPT_PARAMS

Command Description:

This command is sent from the Agent to the station

testing tool extension dll and transfers the running script parameters.
Command Data Structure (Fields):

Script parameters

Remarks:

| | |
|---|---|
| 1. | When the agent receives Load Script command it gets |

the script parameters.

| | |
|---|---|
| 2. | If station testing tool is running, the agent sends the Script |

Parameters to the station testing tool extension DLL before
the script is loaded into the station testing tool. When the
script runs, the Script Parameters will be updated.

| | |
|---|---|
| 3. | If the station testing tool is not loaded, the agent will |

execute the station testing tool, and when the station testing
tool extension DLL loads, the agent will get a message
CMD_WR_IS_UP, and react by sending
CMD_GET_SCRIPT_PARAMS message to the station
testing tool extension DLL.

Command Key:

CMD_WR_IS_UP

Command Description:

This command is sent from the station testing tool

extension DLL to the agent after the station testing tool extension DLL
is loaded by the station testing tool.
Command Data Structure (Fields):

None

Remarks:

| | |
|---|---|
| 1. | The Agent reacts to this message by sending Script |

parameters and all the Synchronization points that were sent
to the station before the station testing tool was run.

Command Key:

CMD_WR_IS_DOWN

Command Description:

This command is sent from the station testing tool

extension DLL to the agent when the station testing tool extension DLL
is unloaded by the station testing tool.
Command Data Structure (Fields):

None

Remarks:

| | |
|---|---|
| 1. | After the Agent receives this message, every |

Synchronization point is stored until the agent receives the
CMD_WR_IS_UP message.

Command Key:

CMD_LOAD_AGENT

Command Description:

This command loads the Display Agent.

Command Data Structure (Fields):

None

Remarks:

| | |
|---|---|
| 1. | This command is sent from the controller to the station |

testing tool extension DLL. The station testing tool extension
DLL loads the Display Agent.

| | |
|---|---|
| 2. | If station testing tool is not running the command does |

not works.

Command Key:

CMD_LOAD_AGENT_ACK

Command Description:

This command acknowledges the message for loading
Display Agent command.

Command Data Structure (Fields):

Sender station

Remarks:

| | |
|---|---|
| 1. | This command is sent from the interface agent to |

the controller when it receives Load Display Agent
command and also when the create process command
succeeds or the Display Agent already exists.

Command Key:

CMD_UNLOAD_AGENT

Command Description:

This command unloads the Display Agent.

Command Data Structure (Fields):

None

Remarks:

| | |
|---|---|
| 1. | This command is sent from the controller to the Display |

Agent. The Display Agent closes itself.

Command Key:

CMD_DISP_AGENT

Command Description:

This command updates the interface agent about the
loading state of the Display Agent and sends data request
to controller.

Command Data Structure (Fields):

Station name
Display Agent status

The Display Agent status can be one of the following values:
STAT_DISP_AGENT_UP
STAT_DISP_AGENT_DOWN
Remarks:

| | |
|---|---|
| 1. | This command is sent from Display Agent when it is |

loaded.

| | |
|---|---|
| 2. | The command is sent to the controller. As a result, |

the controller sends a list of Synchronization points back
to the Display Agent.

| | |
|---|---|
| 3. | This command is sent to interface agent, if the status is |

STAT_DISP_AGENT_UP the interface agent lets the
Display Agent perform commands. If the status is
STAT_DISP_AGENT_DOWN the interface agent will
start to perform commands.

Reference is now made to FIG. 15, which is a simplified block diagram of a hierarchical application system, useful in describing the operation of an embodiment of the present invention.

The hierarchical system of FIG. 15 is characterized by one master station 300 having networked communications with a plurality of slave stations 302. Such a hierarchical system might contain several levels, with some or all of slave stations 302 serving as master stations with respect to a lower level of the hierarchy. Only one level of slaves is presented in the example of FIG. 15, but the principle of operation in such a system is similar to that for multiple hierarchical levels.

Reference is now also made to FIG. 16, which is a simplified flow chart presenting recommended steps of a procedure for testing the hierarchical system of FIG. 15, according to a preferred embodiment of the present invention. As shown in FIG. 16, a preferred testing procedure comprises the following steps. At step 310 a tester plans a test. At step 320 he builds an appropriate set of scripts. At step 330 he defines an appropriate MST running configuration. At step 340 he runs the MST, and at step 350 he analyzes the MST running result.

Referring now to step 310, a full test procedure is prepared. The procedure definition should include statements of the purpose of the test, a general description, and all the inputs and the expected results for each station that is involved in the test.

The following is a simplified general description of the test of the present example:

Master station initializes.

Slave stations wait until the Master station has initialized.

After Master station has initialized, the Slave stations do some application checks.

The Master station waits until all the Slaves stations finish their checks.

The Slaves stations notify the Master station about the results of the checks (succeed or failed).

The Master station finishes successfully only if all the Slaves stations finish successfully.

A script of a Slave station comprises the following steps:

wait_for_sync(“master_is_up”,master_station);
results_status = do_check( );
release_sync(master_station,”slave_finish”,result_status);
report_to_controller(result_status”the test is “ & result_status);
test_running_status(result_status);

A script of a Master station comprises the following steps:

get_my_station(master_ws);
get_script_parameters(slaves_list);
release_sync(slaves_list,”master_is_up”,master_ws);
total_status = “SUCCESS”;
slaves_number = get_number(slaves_list);
for (i=0; i< slaves_number; i++)
{

wait_for_sync(“slave_finish”,result_status);
if (result_status == “FAILED”) total_status = “FAILED”;

}
test_running_status(total_status);

The operation of the master script and slave script here presented will be examined with respect to the behavior of the system controlled by these scripts during a test, in Table 7 hereinbelow.

Referring again to FIG. 16, at step 330 a tester creates a MST file, optionally through the use of the MST Controller application. He writes into the MST file the following information:

He gives a short description of the test scenario.

He optionally links the test plan prepared in step 310

He defines a list of stations that are involved in the test.

He defines a script for a station testing tool 238 for each station.

Typically, a single script may be used for a plurality of slave stations.

He can add parameters for each script to be transferred while the script is running.

Table 6 presents a MST for the Master and Slave test of the present example.

TABLE 6
MASTER/SLAVE MST

| Station | Script | Parameters |
|---|---|---|
| Station_A | Master Script | Station_B;Station_C |
| Station_B | Slave Script | |
| Station_C | Slave Script | |

Short Description:
This test checks the behavior of Slaves stations.
The Slaves stations will do checks only after the Master station is up. All the Slave stations will notify the test results to the Master station. The Master finishes successfully only of if all the Slaves stations finish successfully.
Note:
In the script parameters of the Master station, a list of Slaves stations is transterred.

At step 340, a tester runs the MST defined in table 7. He may run the MST via the MST Controller application. In the present example the MST is run in isolation, but it may be noted that such a MST may also be run as part of MSTs list under the MST Scheduler.

In operation, the tester opens a MST file in the coordinator/controller application. Optionally he may modify it, for example by suspending running of one of the Slave stations, or by adding additional slave stations to be tested.

After the running configuration has been set appropriately, the tester gives the Run command. The MST Controller then loads the station testing tool with the correct script on all the stations that are specified. The station testing tool starts running all those scripts simultaneously.

Table 7 presents the progressive effect of the operation of the master script and of the slave script on their respective targets.

TABLE 7
PROGRESSIVE DESCRIPTION OF RUNNING SCRIPTS

Station Type:

Slave

Command:

wait_for_sync(“master_is_up”, master_station)

Description:

The Slave station starts with waiting for the synchronization point

“master_is_up”, and expects to retrieve the Master station identification
while the Master Station releases this synchronization point.
Station Type:

Master

Command:

get_my_station(master_ws)

Description:

The Master station starts by asking the system “who am I?”. It does

it by using the command get_my_station(master_ws). This command
retrieves the current station identification into the variable master_ws.
Station Type:

Master

Command:

get_script_parameters(slaves_list)

Description:

In the next step, the Master station retrieves the script parameters

from the controller. These parameters are defined in the controller
application. In the example, the script parameters are a list of Slave
stations. This action is performed by the command get_script_
parameters(slaves_list). After performing this command the variable
slaves_list will contain e.g.,
“Station_A;Station_B;Station_C;Station_D”.
Station Type:

Master

Command:

release_sync(slaves_list,”master_is_up”,master_ws)

Description:

After the Master station retrieves the Master station Id and the Slaves

list, the Master is ready to release the waiting Slaves. It does this by
using the command release_sync(slaves_list,”master_is_up”,
master_ws).
Station Type:

Master

Commands:

slaves_number = get_number(slaves_list);
for (i=0; i< slaves_number; i++)
{

wait_for_sync(“slave_finished”,result_status);

}

Description:

On the Master station, the script calculates the number of Slaves

stations (in the example of FIG. 15 there are four Slaves) and waits for
the synchronization point “slave_finished” according to the number
of Slaves. The script finishes waiting only after the synchronization
point “slave_finished” has been released by each of the slave stations.
Station Type:

Slave

Command:

wait_for_sync(“master_is_up”,master_station)

Description:

In the Slaves' stations, when the Master station releases the

synchronization point “master_is_up”, the scripts in these stations
proceed to the next command and the variable master_station contain
the Master station identification.
Station Type:

Slave

Command:

resuls_status = do_check( )

Description:

The next step in the Slaves' station is to do some checks on the tested

application. The command resuls_status = do_check( ) performs
these checks and the result of these checks is returned in the variable
result_status.
Station Type:

Slave

Command:

release_sync(master_station,”slave_finish”,result_status).

Description:

After the Slave station finishes to check the application, it releases the

Master station that was waiting for the Slave's check results. While
the Slave releases the Master, it also notifies the Master about the
check results. The Slave knows the Master's station due to this Master
station identification, which it retrieved from the Master station.
This step is performed by the command release_sync(master_station,
”slave finished”, result_status).
Station Type:

Slave

Command:

report_to_controller(result_status,”the test is “ & result_status)

Description:

After the Slave releases the waiting Master station it reports the test

result to the MST Controller. This operation is performed by the
command report_to_controller(result_status, ”the test is “ &
result_status). This command adds a new entry in the MST report log.
Station Type:

Slave

Command:

test_running_status(result_status)

Description:

At the end of the Slave's script, it notifies the MST Controller that

the running is finished. It also notifies the Running Status, which
indicates the MST Controller of the way the station finished these
checks. This operation is performed by using the command test_running_{—}
status(result_status).
Station Type:

Master

Commands:

wait_for_sync(“slave_finished”,result_status);
if (result_status == “FAILED”) total_status = “FAILED”;

Description:

When the Master station is released by a Slave station, the master

station retrieves the Slave check results in the synchronization point
data parameter. According to the results, the Master station decides
if the test FAILED or SUCCEED. If one Slave finished the test with
FAILED status, the Master station will finish as failed.
Station Type:

Master

Command:

test_running_status(total_status)

Description:

At the end of the Master script it notifies the MST Controller

about the completion of running script in the Master station with
the Test Running Status (FAILD or SUCCESS). It is done by the
command test_running_status(total_status)

Referring again to FIG. 16, at step 350 the tester checks and analyzes the MST running result. The running of MST produces the MST Central Report. This report includes a list of messages gathered from the tested stations. The report is composed of columns, such as the station that sent each message and a list of user defined fields such as the script step, and free text that explains the problem that was found.

The MST Central Report can be exported to an external analyzing system, for the production of charts or other forms of summarizing and analyzing reports.

It may be noted that the embodiments described herein provide solutions to a variety of problems presented in the discussion of the background of the invention, which problems were described as not being adequately solveable using techniques of prior art.

Recalling the example of a software testing system required to test a three-station application system in which

Station A goes through an initialization procedure, does a calculation on a set of data, then sends a calculated result to station C,

Station B also goes through an initialization procedure, also does a calculation on a set of data, and also sends a calculated result to station C,

Station C waits until it receives a calculation result, either from station A or from station B, and then immediately proceeds to calculate a final result,

the problem is adequately solved using the following set of scripts, according to an embodiment of the present invention:

Station A:

DoInitialCalculation ( )

SendResultOfCalculation ( )

ReleaseSyncPoint (1)

Station B:

DoInitialCalculation ( )

SendResultOfCalculation ( )

ReleaseSyncPoint (1)

Station C:

WaitForSyncPoint (1)

ReceiveResultsOfinitialCalculation ( )

DoFinalCalculation ( )

According to the above set of scripts, station C waits only until either Station A or Station B (but not both stations) has completed the initial calculation and sent a result. No time is lost waiting for both stations to complete the initial calculation, and no failure results if one of the stations fails to complete the initial calculation.

In a further example, the message-sending capabilities of the ReleaseSyncPoint ( ) command enable processes running on a first station to be made aware of the status of processes running on a second station, even when no visible common output events are involved.

In a further example, reconsidering now the situation mentioned in the background section above wherein a station A is required to send a message to a station B and then execute a set of internal tests, and station B is required to do internal tests and then receive the message from station A, this problem is easily and efficiently solved using the following scripts, according to an embodiment of the present invention:

Station A:

SendMessageToStationB ( )

ReleaseSync (“mail is sent”)

DoInternalTestsInStationA ( )

Station B:

DoInternalTestsInStationB ( )

WaitForSync (“mail is sent”)

ReceiveMessageFromStationA ( )

Since the ReleaseSync ( ) command is not a rendezvous point, station A executes the ReleaseSync ( ) command and can proceed immediately to execute its internal tests, without waiting. Similarly, station B does its internal tests, and waits only if it is ready to receive the message from station A before station A has in fact sent it. No time is wasted by either station.

In a further example, it is clear from the syntax of the synchronization point commands presented in Table 1 that that set of commands provides adequate means for a script running on a first station to evaluate the output of a first process running on that first station, and to inform additional processes running on additional remote stations of the result of that evaluation. Thus, the command structure provided by an embodiment of the present invention and presented in Table 1 provides mechanisms whereby a first set of input may be sent to a second station in the case where a first process on a first station completes successfully, and a second set of input may be sent to a second station in the case where a first process on a first station does not complete successfully.

It may further be noted that in a preferred embodiment of the present invention, the synchronization capabilities described hereinabove are part of a script language which may be implemented on individual stations. That is, in a preferred embodiment, the use of synchronization points does not require the presence of a controller running as a separate process. An independent controller may be used, in which case it is particularly useful for defining a test, scheduling the running of a test or series of tests, for displaying the status of the processes (and in particular of the synchronization points) on a plurality of stations, for intervening in a process by sending data messages to operating units or to processes as if those data messages had come from one of the plurality of tested stations, and for collecting information about, and centralized reporting of, processing events occuring on a plurality of stations. Yet in a preferred embodiment, synchronization of events among stations may be implemented at the level of scripts running on individual stations or on selected subsets of the plurality of stations running a multi-station application, thus greatly facilitating the creating, maintaining, and debugging of testing scripts, and the debugging and testing of multi-user multi-station applications implemented as a plurality of applications distributed on networked stations.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

We claim:

1. Supervisor apparatus for running an integrated operation on a plurality of applications distributed on networked stations, the apparatus comprising:
(a) an evaluating unit for receiving and evaluating output from at least two stations including a first station and at least one other station, and
(b) an operating unit for sending selected commands to a first application running on said first station, said commands being selectable according to rules, said rules specifying a dependency of a command to be sent to said first station upon an evaluation of output from said at least one other station.

2. Supervisor apparatus according to claim 1, where said rules are embodied in a computer program.

3. Supervisor apparatus according to claim 1, where said rules are scripts.

4. Supervisor apparatus according to claim 1, where said rules comprise a synchronization point, said synchronization point comprising functionality to require unidirectional temporal dependency of a command to one station upon received outputs from said other station.

5. Supervisor apparatus according to claim 1, where said operating unit is a process running on said first station.

6. Supervisor apparatus according to claim 1, where said operating unit is a process running on a station other than said first station.

7. Supervisor apparatus according to claim 1, wherein said apparatus is designed and constructed for sending commands to a plurality of applications running on a plurality of stations.

8. Supervisor apparatus according to claim 1, wherein said apparatus is designed and constructed for testing said applications.

9. Supervisor apparatus according to claim 8, wherein said apparatus is for functional testing of said applications.

10. Supervisor apparatus according to claim 8, wherein said apparatus is for regressive testing of said applications.

11. Supervisor apparatus according to claim 1, wherein said apparatus comprises a testing unit for testing said integrated operation.

12. Supervisor apparatus according to claim 11, wherein said apparatus comprises a functional testing unit for functional testing of said integrated operation.

13. Supervisor apparatus according to claim 11, wherein said apparatus comprises a regressive testing unit for regressive testing of said integrated operation.

14. Supervisor apparatus according to claim 1, wherein said integrated operation is a test operation.

15. Supervisor apparatus according to claim 14, wherein said integrated test comprises functional tests on said applications.

16. Supervisor apparatus according to claim 14, wherein said integrated test comprises regressive tests on said applications.

17. Supervisor apparatus according to claim 14, wherein said distributed applications are test applications operative to test locally installed test subject applications.

18. Supervisor apparatus according to claim 17, wherein said distributed applications comprise at least one of a group comprising functional testing ability and regressive testing ability.

19. Supervisor apparatus according to claim 1, wherein said rules comprise scripts for interacting with a plurality of applications.

20. Supervisor apparatus according to claim 19, wherein said supervisor apparatus is operable to freeze running of said scripts at at least one of said applications until receipt of a predetermined output from a predetermined other of said applications.

21. Supervisor apparatus according to claim 19, wherein said supervisor apparatus is operable to freeze running of said scripts at at least one of said applications until receipt of an indication that a predetermined other of said applications is ready to carry out a given operation.

22. Supervisor apparatus according to claim 19, wherein said interaction is a test.

23. Supervisor apparatus according to claim 1, comprising a synchronization point definer operable to define synchronization points in said integrated operation, said synchronization points being usable at a station to temporally affect operation at said station.

24. Supervisor apparatus according to claim 23, said synchronization point definer being operable to include, with said synchronization point, a definition comprising a list of at least one station to use said synchronization point.

25. Supervisor apparatus according to claim 23, said synchronization point definer being operable to include, with said synchronization point, a definition comprising a list of at least one station to respond thereto in a first way and a list of at least one station to respond thereto in a second way.

26. Supervisor apparatus according to claim 23, said synchronization point definer being operable to include, with said synchronization point, a definition comprising at least two events from evaluations made by said evaluator.

27. Supervisor apparatus according to claim 26, wherein at least one of said two events is an evaluation of output from said first station and at least one of said two events is an evaluation of output from said second station.

28. Supervisor apparatus according to claim 26, said synchronization point definer being operable to include, with said synchronization point definition, a list of at least one station to react to a first of said events and at least one station to react to at least a second of said events.

29. Supervisor apparatus according to claim 26, wherein said first event comprises an indication of successful sending of data from a first station and said second event comprises an indication of successful receipt of said data at a second station.

30. Supervisor apparatus according to claim 26, wherein said first event comprises an indication of successful sending of data from a first station and said second event comprises an indication of unsuccessful receipt of said data at a second station.

31. Supervisor apparatus according to claim 23, wherein said synchronization point definer is operable to define, for at least one station, a maximum time delay for waiting for an event associated with said synchronization point.

32. Supervisor apparatus according to claim 31, wherein said synchronization point definer is operable to define different maximum time delays for different stations.

33. Supervisor apparatus according to claim 1, further comprising an event occurrence notifier operable to inform one of said stations about occurrence of an event at another of said stations.

34. Supervisor apparatus according to claim 33, being operable to include supervisor generated data regarding said occurrence.

35. Supervisor apparatus according to claim 33, being operable to include station generated data regarding said occurrence.

36. Supervisor apparatus according to claim 1, wherein said evaluating unit is operable for evaluating output from at least two of said stations together.

37. A system for running an integrated operation on a plurality of applications distributed on networked stations, the system comprising:
(a) a plurality of supervisor apparatus units for running an integrated operation on a plurality of applications distributed on networked stations, at least one of said supervisor apparatus units comprising:
(i) An evaluating unit for receiving and evaluating output from at least two stations, including a first station and at least one other station,
(ii) an operating unit for sending selected commands to a first application running on said first station, said commands being selectable according to rules, said rules specifying a dependency of a command to be sent to said first station upon an evaluation of output from at least said other station, and
(b) a coordinator for coordinating operation of said plurality of supervisor apparatus.

38. The system of claim 37, wherein said coordinator is operable for sending parameters to said supervisor apparatus, for affecting operation of said rules.

39. The system of claim 37, wherein said coordinator is operable for sending sets of rules to said supervisor apparatus, for use by said supervisor apparatus in running integrated operations on a plurality of applications distributed on networked stations.

40. The system of claim 37, wherein said sets of rules are for testing said applications.

41. The system of claim 40, wherein said testing comprises a functional test.

42. The system of claim 40, wherein said testing comprises a regressive test.

43. The system of claim 37, wherein said sets of rules are for testing said integrated operation.

44. The system of claim 43, wherein said testing comprises a functional test.

45. The system of claim 43, wherein said testing comprises a regressive test.

46. The system of claim 37, wherein said coordinator comprises a logging unit for collecting and recording output from at least some of said networked stations.

47. The system of claim 46, wherein said coordinator comprises a report generator, associated with said logging unit, for generating reports based on said collected output.

48. The system of claim 47, wherein said report generator comprises a summarizer for summarizing said collected output.

49. The system of claim 47, wherein said report generator comprises a describer for evaluating and characterizing said collected output.

50. Test apparatus for running on a first station to test an application thereon, said test to be integrated with tests on remotely located other stations networked therewith, the apparatus comprising:
(a) an operating unit for sending selected commands to said application, said commands being selectable according to rules, said rules specifying a dependency of a command to be sent to said application upon an evaluation of output at least one of said remote stations, and
(b) An evaluator, associated with said operation unit, for selecting commands to be sent to said application according to an evaluation of outputs received from said remote stations, said evaluation being dependent on said rules, thereby to control flow of said commands locally at said first station in accordance with said outputs received from said at least one remote station.

51. Test apparatus according to claim 50, wherein said first station is a remote station.

52. Test apparatus according to claim 50, wherein said rules comprise synchronization at predetermined synchronization points.

53. Test apparatus according to claim 50, wherein said rules are suppliable to said operating unit by a remote coordinator.

54. Test apparatus according to claim 50, wherein said test comprises functional tests on said application.

55. Test apparatus according to claim 50, wherein said test comprises regressive tests on said application.

56. Test apparatus according to claim 50, wherein said outputs comprise the results of test scripts run by each test application, and wherein said evaluator is operable to freeze running of a respective test script until receipt of a predetermined output from a predetermined other of said applications.

57. Test apparatus according to claim 50, wherein said outputs are the results of test scripts run by each test application, and wherein said evaluator is operable to freeze running of a respective test script until receipt of an indication that a predetermined other application at a remote station is ready to carry out a given operation.

58. Supervisor method for running an integrated operation on a plurality of applications distributed on networked stations, the method comprising:
(a) sending selected commands to at least one application of said plurality of applications, said application running on a first station,
(b) receiving and evaluating output from said at least one application and from at least one other station, and
(c) selecting commands for sending to said application, said selection being dependent on rules, said rules specifying a dependency of a command to be sent to said first application upon an evaluation of output from said other station.

59. Method according to claim 58, wherein said integrated operation is a test operation.

60. Method according to claim 59, wherein said integrated test comprises functional tests on said applications.

61. Method according to claim 59, wherein said integrated test comprises regressive tests on said application.

62. Method according to claim 59, wherein said distributed applications are test applications operative to test locally installed test subject applications.

63. Method according to claim 62, wherein said distributed applications comprises at least one of a group comprising functional testing ability and regressive testing ability.

64. Method according to claim 58, wherein said rules comprise a synchronization point comprising a requirement for unidirectional temporal dependency between a command on one station and received outputs from said other stations.

65. Method according to claim 58, further comprising utilizing a synchronization point definer to define synchronization points in said integrated operation, said synchronization points being usable at a station to temporally affect operation at said station.

66. Method according to claim 58, further comprising utilizing a synchronization point definer to define a synchronization point in said integrated operation, said synchronization point being usable at a plurality of said stations to temporally affect operation at a selected ones of said stations.

67. Method according to claim 65, further comprising utilizing said synchronization point definer to define, with said synchronization point, a list of at least one station to use said synchronization point.

68. Method according to claim 65, further comprising utilizing said synchronization point definer to define, with said synchronization point, a list of at least one station to respond thereto in a first way and a list of at least one station to respond thereto in a second way.

69. Method according to claim 65, further comprising utilizing said synchronization point definer to define, with said synchronization point, a list of at least two events from said evaluation.

70. Method according to claim 69, said further comprising utilizing said synchronization point definer to define, with said synchronization point, a list of at least one station to react to a first of said events and a list of at least one station to react to at least a second of said events.

71. Method according to claim 70, wherein said first event comprises an indication of successful sending of data from a first station and said second event comprises an indication of successful receipt of said data at a second station.

72. Method according to claim 70, wherein said first event comprises an indication of successful sending of data from a first station and said second event comprises an indication of unsuccessful receipt of said data at a second station.

73. Method according to claim 70 comprising defining, for at least one station, a maximum time delay for waiting for a synchronization event associated with said synchronization point.

74. Method according to claim 73, comprising defining different maximum time delays for different stations.

75. Method according to claim 62, wherein said outputs comprise the results of test scripts run by each test application.

76. Method according to claim 75, further comprising freezing running of a script at a first application until receipt of a predetermined output from a predetermined other of said applications.

77. Method according to claim 75, further comprising freezing running of a script at a first application until receipt of an indication that a predetermined other of said applications is ready to carry out a given operation.

78. Method according to claim 62, comprising informing any one of said stations about occurrence of an event at any other of said stations.

79. Method according to claim 78, comprising including supervisor generated data regarding said occurrence.

80. Method according to claim 78, comprising including station generated data regarding said occurrence.

81. Method according to claim 58, further comprising debugging in accordance with output from at least one of said stations.

82. Testing method for testing an integrated operation running as a plurality of applications distributed on networked stations, the method comprising:
(a) sending selected commands to at least one application of said plurality of applications, said application running on a first station,
(b) receiving and evaluating output from said at least one application and from at least one other station,
(c) selecting commands for sending to said application, said selection being dependent on rules, said rules specifying a dependency of a command to be sent to said first application upon an evaluation of output from said other station,
(d) comparing said received output to a body of expected output, and
(e) reporting differences between said received output and said expected output,
thereby testing whether said received output conforms to expectations.

83. Testing method of claim 82, wherein said comparison of said received output to said body of expected output comprises a functional test of said integrated operation.

84. Testing method of claim 82, wherein said comparison of said received output to said body of expected output comprises a regressive test of said integrated operation.

85. Testing method of claim 82, wherein said comparison of said received output to said body of expected output comprises a functional test of said at least one application.

86. Testing method of claim 82, wherein said comparison of said received output to said body of expected output comprises a regressive test of said at least one application.
